(19) United States
(12) Patent Application Publication
(10) Pub. No.: US 2025/0109275 A1
(43) Pub. Date: Apr. 3, 2025

(54) AMINE FATTY ACID ADDUCTS AS TIRE COMPOUNDING ADDITIVES

(71) Applicant: INGEVITY SOUTH CAROLINA, LLC, North Charleston, SC (US)

(72) Inventors: Andrew Joseph Franjesevic, North Charleston, SC (US); Yongning Liu, North Charleston, SC (US); John C. Widders, North Charleston, SC (US)

(21) Appl. No.: 18/896,534

(22) Filed: Sep. 25, 2024

Related U.S. Application Data
(60) Provisional application No. 63/557,102, filed on Feb. 23, 2024.
(60) Provisional application No. 63/586,065, filed on Sep. 28, 2023.

(51) Int. Cl. C08K 5/20; B60C 1/00; C08J 3/22; C08J 5/04; C08K 3/04; C08K 3/06; C08K 3/22; C08K 3/36; C08K 5/09; C08K 5/18; C08K 5/31; C08K 5/3437; C08K 5/47; C08K 5/548; C08L 9/06

(52) U.S. Cl. CPC C08K 5/20; B60C 1/00; C08J 3/22; C08J 5/04; C08K 3/04; C08K 3/06; C08K 3/36; C08K 5/09; C08K 5/18; C08K 5/31; C08K 5/3437; C08K 5/47; C08K 5/548; C08L 9/06; C08J 2309/06; C08J 2409/00; C08J 2491/06; C08K 2003/2296; C08L 2205/025; C08L 2207/322; C08L 2310/00

(57) ABSTRACT

The present disclosure describes an additive composition for rubber and methods of making and using the same. The additive composition is made by a process including reacting (A) a fatty acid composition with (B) a unsubstituted or substituted, linear or branched poly(alkyl)polyamine. For example, the additive composition can include diethylenetriamine (DETA) oleic acid amidoamine, diethylenetriamine (DETA) oleic acid imidazoline, diethylenetriamine (DETA) oleic acid bisamide, triethylenetetramine (TETA) oleic acid amidoamine, tetraethylenepentamine (TEPA) oleic acid amidoamine, dimethylaminopropylamine (DMAPA) oleic acid amidoamine, or a combination thereof. The present disclosure further describes rubber including the additive composition of the present disclosure, as well as methods of making and using the same.

### CROSS-REFERENCE TO RELATED APPLICATIONS

The present application claims priority to, and the benefit of, U.S. Provisional Patent Application No. 63/557,102, filed 23 Feb. 2024, and U.S. Provisional Patent Application No. 63/586,065, filed 28 Sep. 2023, each of which is titled AMINE FATTY ACID ADDUCTS AS TIRE COMPOUNDING ADDITIVES and incorporated by reference herein its entirety for all purposes.

### TECHNICAL FIELD

The present disclosure relates to an additive composition for use in a rubber composition (e.g., a silica compounded rubber composition) or a tire (e.g., a silica compounded tire). The present disclosure also relates to methods of making the additive composition, rubber compositions and tires comprising the additive composition, and methods of making and using the additive composition and the rubber composition.

### BACKGROUND

The development of high silica loading tires is essential for the advancement and development of electric vehicles (EVs). To meet the demands of electric vehicles (EVs) for weight distribution, and effective range, technology development has focused on the development of low rolling resistance (LRR) tires. Low rolling resistance (LRR) tires (also known as, green tires or energy tires) are tires that have a lower rolling resistance than conventional ones, wherein rolling resistance is the energy loss from a tire rolling across a surface, thereby continually deforming and reforming, resulting in heat buildup. The major differentiating factor between conventional tires and low rolling resistance (LRR) tires is the use of silica. Furthermore, some countries are posing regulatory requirements to monitor and quantify small particle emissions from tires as a result of abrasion or wear, thereby dramatically increasing the importance of these properties in tire performance.

Thus, there is a need in the tire industry for tire compounding additives that will enhance rubber and thus tire performance/properties. The present disclosure provides an additive composition that enhances the properties of silica compounded rubber compositions, including increasing silica dispersion and decreasing Payne Effect of the formulated silica compounded rubber compositions, while maintaining the Mooney viscosity, Mooney scorch, hardness, tensile strength, elongation/strain, abrasion resistance, and modulus of the silica compounded rubber in acceptable ranges. The silica compounded rubber of the present disclosure surprisingly and unexpectedly has increased/stronger fuel economy, enhanced/stronger winter traction, enhanced/stronger dry traction, and enhanced/stronger dry handling.

### SUMMARY

Presently described are additive compositions for rubber (e.g., silica compounded rubber compositions), as well as methods of making and using the same, and rubbers and tires comprising the additive compositions of the present disclosure, as well as methods of making and using the same.

An aspect of the present disclosure provides an additive composition (e.g., an additive composition for a silica compounded rubber composition) made by a process comprising, consisting essentially of, or consisting of, reacting (A) a fatty acid composition with (B) a unsubstituted or substituted, linear or branched polyalkylpolyamine (e.g., a linear polyalkylpolyamine that is optionally substituted with one or more methyl groups).

In any aspect or embodiment described herein, (i) the fatty acid composition includes or is oleic acid, stearic acid, palmitic acid, linoleic acid, linolenic acid, isostearic acid, ricolenic acid, a natural fatty acid mixture, crude tall oil (CTO), distilled tall oil, tall oil fatty acids (TOFA, such as Type I TOFA, Type II TOFA, Type II TOFA, or a combination thereof), vegetable oil, soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof; (ii) the unsubstituted or substituted, linear or branched polyalkylpolyamine includes or is diethylenetriamine (DETA), dimethylaminopropylamine (DMAPA), triethylenetetramine (TETA), tetraethylenepentamine (TEPA), or a mixture thereof; or (iii) a combination thereof.

In any aspect or embodiment described herein, (i) the fatty acid composition includes or is oleic acid, stearic acid, palmitic acid, linoleic acid, linolenic acid, isostearic acid, ricolenic acid, or a mixture thereof; (ii) the unsubstituted or substituted, linear or branched polyalkylpolyamine includes or is diethylenetriamine (DETA), dimethylaminopropylamine (DMAPA), or a mixture thereof; or (iii) a combination thereof.

In any aspect or embodiment described herein, (i) the fatty acid composition includes or is oleic acid; (ii) the unsubstituted or substituted, linear or branched polyalkylpolyamine includes or is diethylenetriamine (DETA); or (iii) a combination thereof.

In any aspect or embodiment described herein, the additive composition includes, consists essentially of, or consists of, one or more (e.g., 1, 2, 3, 4, 5, or more) compound with the chemical structure:

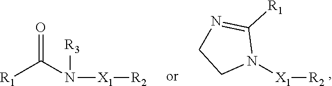

wherein:
X₁ has the chemical structure

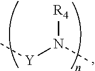

wherein n is an integer from 1, 2, 3, 4, or 5;
X₂ has the chemical structure

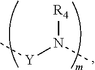

wherein m is an integer from 1, 2, 3, 4, or 5;
Y is a C₁₋₄ hydrocarbon chain;
R₁ is a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups;
R₂ is a hydrogen, a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups, or

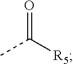

R₃ is a hydrogen or a C₁₋₆ linear or branched alkyl;
each R₄ is a hydrogen or a C₁₋₆ linear or branched alkyl; and
R₅ is a C₈₋₃₆ hydrocarbon chain with 1, 2, or 3 degrees of unsaturation (e.g., a C₈₋₂₂ hydrocarbon chain with 1, 2, or 3 degrees of unsaturation or a C₈₋₂₂ or C₈₋₁₈ hydrocarbon chain with 1 or 2 degrees of unsaturation), optionally 1, or 2 carbonyl groups and/or carboxylic groups.

In any aspect or embodiment described herein, R₂ is a hydrogen, C₈₋₃₆, C₈₋₂₂, or C₈₋₁₈ hydrocarbon chain with 0, 1, or 2 degrees of unsaturation (e.g., C₈₋₃₆, C₈₋₂₂, or C₈₋₁₈ hydrocarbon chain with 1 or 2 degrees of unsaturation) and optionally 1 or 2 carbonyl groups and/or carbocyclic groups, or

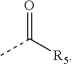

In any aspect or embodiment described herein, R₂ is a hydrogen or C₈₋₃₆, C₈₋₂₂, or C₈-18 hydrocarbon chain with 0, 1, or 2 degrees of unsaturation (e.g., C₈₋₃₆, C₈₋₂₂, or C₈₋₁₈ hydrocarbon chain with 1 or 2 degrees of unsaturation) and optionally 1 or 2 carbonyl groups and/or carbocyclic groups.

In any aspect or embodiment described herein, R₂ is a hydrogen, C₈₋₃₆, C₈₋₂₂, or C₈₋₁₈ hydrocarbon chain with 0 or 1 degrees of unsaturation (e.g., C₈₋₂₂ or C₈₋₁₈ hydrocarbon chain with 0 or 1 degrees of unsaturation) and optionally 1 or 2 carbonyl groups and/or carbocyclic groups, or

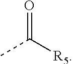

In any aspect or embodiment described herein, R₂ is a hydrogen, C₈₋₂₂ or C₈₋₁₈ hydrocarbon chain with 1, 2, or 3 degrees of unsaturation, or

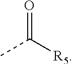

In any aspect or embodiment described herein, R₂ is a hydrogen or

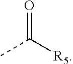

In any aspect or embodiment described herein, the additive compositions (e.g., an additive composition for a silica compounded rubber composition) comprising, consisting essentially, or consisting of: diethylenetriamine (DETA) oleic acid amidoamine, diethylenetriamine (DETA) oleic acid imidazoline, diethylenetriamine (DETA) oleic acid bisamide, triethylenetetramine (TETA) oleic acid amidoamine, tetraethylenepentamine (TEPA) oleic acid amidoamine, dimethylaminopropylamine (DMAPA) oleic acid amidoamine, or a combination thereof.

In any aspect or embodiment described herein, the additive composition comprises, consists essentially, or consists of: diethylenetriamine (DETA) oleic acid amidoamine, diethylenetriamine (DETA) oleic acid bisamide, or a combination thereof.

In any aspect or embodiment described herein, the additive composition comprises, consists essentially, or consists of, diethylenetriamine (DETA) oleic acid amidoamine.

In any aspect or embodiment described herein, the additive composition comprises, consists essentially, or consists of, diethylenetriamine (DETA) oleic acid bisamide.

A further aspect of the present disclosure provides the use of the additive composition of the present disclosure in a rubber (e.g., a rubber composition or a silica compounded rubber composition).

Another aspect of the present disclosure provides the use of the additive composition of the present disclosure in a tire (e.g., a silica compounded tire).

An additional aspect of the present disclosure provides a rubber composition comprising, consisting essentially of, or consisting of: the additive composition (e.g., an additive composition for a silica compounded rubber composition) of the present disclosure; one or more (e.g., 1, 2, 3, 4, 5, 6, or more) elastomer (e.g. one or more functionalized elastomer); and one or more (e.g., 1, 2, 3, 4, 5, 6, or more) filler (e.g., a reinforcing filler) that includes silica (e.g., fumed silica, precipitated silica, pre-treated precipitated silica, silicon dioxide, zeolites, clays (e.g., kaolinite), silicate minerals, inorganic silicate, or a combination thereof).

In any aspect or embodiment described herein, (a) the one or more elastomer includes one or more (e.g., 1, 2, 3, 4, 5, 6, or more) natural rubber, one or more (e.g., 1, 2, 3, 4, 5, 6, or more) synthetic rubber, or a combination thereof; (b) the one or more elastomer includes a synthetic rubber that includes one or more diene-based rubber; (c) the one or more elastomer includes a synthetic rubber that includes one or more diene-based rubber that includes a styrene-butadiene copolymer rubber (e.g., solution styrene-butadiene rubber), a polybutadiene (e.g., high cis-1,4-polybutadiene, high cis-1,4-polybutadiene stabilized with a non-staining antioxidant), or a combination thereof; (d) the one or more elastomer includes a functionalized elastomer (e.g., a tin, silicon, and/or amine coupled elastomer, terminated elastomer, or coupled and terminated elastomer); (c) the silica is silicon dioxide; or (f) a combination thereof.

In any aspect or embodiment described herein, the rubber composition further comprises, consists essentially of, or consists of: (a) one or more (e.g., 1, 2, 3, 4, 5, 6, or more) plasticizer; (b) one or more (e.g., 1, 2, 3, 4, 5, 6, or more) coupling agent (e.g., an organosilane or sulfur functional organosilanes); or (c) a combination thereof.

In any aspect or embodiment described herein, (a) the one or more plasticizer includes a processing oil (e.g. a rubber processing oil, mineral oil, vegetable oil, vegetable oil ester, or a mixture thereof), an aromatic oil (e.g., distillate aromatic extract, treated distillate aromatic extract, or a mixture thereof), or a combination thereof; (b) the one or more coupling agent includes sulfur functional organosilanes, bis(triethoxysilylpropyl) tetrasulfide, bis(triethoxysilylpropyl) disulfide, 3-thiocyanatopropyltriethoxysilane, or a mixture thereof; or (c) a combination thereof.

In any aspect or embodiment described herein, the rubber composition further comprising, consisting essentially of, or consisting of: (a) one or more (e.g., 1, 2, 3, 4, 5, 6, or more) antiaging agent (e.g., an antioxidant, an antiozonant, or a combination thereof); (b) one or more (e.g., 1, 2, 3, 4, 5, 6, or more) vulcanization accelerator (e.g., a sulfonamide-based accelerator); or (c) a combination thereof.

In any aspect or embodiment described herein, (a) the one or more vulcanization accelerator includes stearic acid, zinc oxide, or a combination thereof; (b) the one or more antiaging agent includes one or more (e.g., 1, 2, 3, 4, 5, 6, or more) antioxidant (e.g., N1-(4-methylpentan-2-yl)-N4-phenylbenzene-1,4-diamine (6PPD), polymerized 2,2,4-Trimethyl-1,1-dihydroquinoline (TMQ), or a mixture thereof); (c) the one or more antiaging agent includes one or more (e.g., 1, 2, 3, 4, 5, 6, or more) antiozonant (e.g., a wax, paraffin wax, refined paraffin wax, refined paraffin was derived from petroleum, a fully refined paraffin wax derived from petroleum, or a mixture thereof); (d) the one or more filler include one or more (e.g., 1, 2, 3, 4, 5, 6, or more) carbon black (e.g., N330 carbon black, N234 carbon black, LH30 carbon black, N326 carbon black, N339 carbon black, N351 carbon black, N550 carbon black, N650 carbon black, N660 carbon black, or a mixture thereof (e.g., based on the American Society for Testing and Materials (ASTM) Committee D24 on Carbon Black nomenclature)); (c) the one or more filler includes N330 carbon black; or (f) a combination thereof.

In any aspect or embodiment described herein, (a) the rubber further comprises, consisting essentially of, or consisting of, one or more (e.g., 1, 2, 3, 4, 5, 6, or more) cross-linking or vulcanization agent (e.g. sulfur); (b) the one or more vulcanization accelerator include (e.g., a sulfonamide-based accelerator or N-tert-butyl-benzothiazole sulfonamide (TBBS)); (c) the one or more coupling agent further includes diphenyl guanidine (DPG) (e.g., oxybispropanol, mixture of structural isomers of oxybispropanol; 1,1′-oxybis-2-propanol; 2,2′-oxybis-1-propanol; 2-(2-hydroxypropoxy)-1-propanol; or a mixture thereof); or (d) a combination thereof.

In any aspect or embodiment described herein, (a) the synthetic rubber is present in an amount of at least 50 parts per hundred of rubber (PHR) (e.g., at least 75 PHR, at least 80 PHR, at least 85 PHR, at least 90 PHR, at least 95 PHR, at least 98 PHR, at least 99 PHR, or 100 PHR); (b) the additive composition is present in an amount of about 1 to about 10 PHR (e.g., about 1 to about 5 PHR, about 2 to about 4 PHR or about 3 PHR); (c) the one or more filler is/are present in an amount of about 50 to about 150 PHR (e.g., about 50 to about 125 PHR, about 50 to about 100 PHR, about 72 to about 102 PHR, about 77 to about 97 PHR, or about 87 PHR); (d) the one or more plasticizer is/are present in an amount of about 15 to about 50 PHR (e.g., about 15 to about 45 PHR or about 32 PHR); (c) the one or more coupling agent is/are present in an amount of about 4 to about 12 PHR (e.g., about 6 to about 10 PHR or about 8 PHR); (f) the one or more vulcanizing accelerator is/are present in amount of about 2 to about 8.5 PHR (e.g., about 5.2 PHR); (g) the one or more antiaging agent is/are present in an amount of about 3 to about 8 PHR (e.g., about 4 to about 7 PHR or about 5.5 PHR); (h) the one or more cross-linking or vulcanization agent is/are present in an amount of about 0.4 to about 2.4 PHR (e.g., about 0.9 to about 1.9 PHR or about 1.4 PHR); or (i) a combination thereof.

In any aspect or embodiment described herein, (a) the styrene butadiene copolymer rubber is present in an amount of about 60 to about 90 parts per hundred of rubber (PHR) (e.g., about 75 PHR); (b) the polybutadiene is present in an amount of about 10 to about 40 PHR (e.g., about 25 PHR); (c) the one or more silica is/are present in an amount of about 55 to about 150 PHR (e.g., about 55 to about 125 PHR, about 55 to about 95 PHR, about 65 to about 85 PHR or about 75 PHR); (d) the one or more carbon black is/are present in an amount of about 5 to about 20 PHR (e.g., about 7 to about 17 PHR or about 12 PHR); (c) the organosilane or sulfur functional organosilane is present in an amount of about 4 to about 8 PHR (e.g., about 6 PHR); (f) the diphenyl guanidine (DPG) is present in an amount of about 0.5 to about 4 PHR (e.g., about 1 to about 3 PHR or about 2 PHR); (g) the sulfonamide-based accelerator (e.g., N-tert-butyl-benzothiazole sulfonamide (TBBS)) is present in an amount of about 0.5 to about 3 PHR (e.g., about 1 to about 2.5 PHR or about 1.7 PHR); (h) the zinc oxide is present in an amount of about 1 to about 4 PHR (e.g., about 1.5 to about 3.5 PHR or 2.5 PHR); (i) the stearic acid is present in an amount of about 0.5 to about 1.5 PHR (e.g., about 0.75 to about 1.25 PHR or about 1 PHR); (i) the one or more antioxidant is/are present in an amount of about 2 to about 6 PHR (e.g., about 3 to about 5 PHR or 4 PHR); (j) the one or more antiozonant is/are present in an amount of about 1 to about 2 PHR (e.g., about 1.25 to about 1.75 PHR or 1.5 PHR); or (k) a combination thereof.

An aspect or the present disclosure provides a method of making the rubber composition of the present disclosure, the method comprising, consisting essentially of, or consisting of, contacting one or more (e.g., 1, 2, 3, 4, 5, 6, or more) filler that includes one or more (e.g., 1, 2, 3, 4, 5, 6, or more) silica, one or more (e.g., 1, 2, 3, 4, 5, 6, or more) elastomer (e.g. one or more functionalized elastomer), and the additive composition (e.g., an additive composition for silica compounded rubber composition) of the present disclosure.

In any aspect or embodiment described herein, contacting the one or more silica, the one or more rubber, and the additive composition comprises, consisting essentially of, or consisting of: (a) preparing a first mixture comprising, consisting essentially of, or consisting of, combining and/or mixing the one or more elastomer (e.g., a butadiene-based rubber, styrene butadiene copolymer rubber, polybutadiene, or a combination thereof), the one or more silica (e.g., silicon dioxide), the one or more coupling agent (e.g., bis(triethoxysilylpropyl) tetrasulfide), the one or more plasticizer (e.g., distillate aromatic extract, treated distillate aromatic extract, or a mixture thereof), or a combination thereof; (b) preparing a second mixture comprising, consisting essentially of, or consisting of, combining and/or mixing the first mixture, at least one (e.g., 1, 2, 3, 4, 5, or more) of the one or more filler (e.g., carbon black, such as N330 carbon black), at least one (e.g., 1, 2, 3, 4, 5, or more) of the one or more plasticizer (e.g., distillate aromatic extract, treated distillate aromatic extract, or a mixture thereof), the one or more antiaging agent (e.g., polymerized 2,2,4-Trimethyl-1,1-dihydroquinoline (TMQ), N1-(4-methylpentan-2-yl)-N4-phenylbenzene-1,4-diamine (6PPD), paraffin wax, or a combination thereof), the one or more vulcanizing accelerator (e.g., zinc oxide, stearic acid, or a combination thereof), the additive composition, or a combination thereof; (c) preparing a third mixture comprising, consisting essentially of, or consisting of, combining and/or mixing the second mixture, at least one (e.g., 1, 2, 3, 4, 5, or more) of the one or more of the vulcanizing accelerator (e.g., N-tert-butyl-benzothiazole sulfonamide (TBBS)), at least one (e.g., 1, 2, 3, 4, 5, or more) of the one or more coupling agent (e.g., diphenyl guanidine (DPG)), at least one of the one or more cross-linking or vulcanizing agent (e.g., sulfur), or a combination thereof; or (d) a combination thereof.

In any aspect or embodiment described herein, (i) preparing the first mixture includes, consists essentially of, or consists of: adding the one or more plasticizer to the mixture the one or more elastomer, the one or more silica, and/or the one or more coupling agent, at a temperature of about 75° C. to about 95° C. (e.g., 82° C.); mixing/sweeping the first mixture at a temperature of about 100° C. to about 115° C. (e.g., about 110° C.); mixing/sweeping the mixture at a temperature of about 115° C. to about 135° C. (e.g., about 127° C.); holding the first mixture at a temperature of about 145° C. to about 160° C. (e.g., holding the first mixture for about 2 to 8 minutes or about 2 to about 5 minutes, and/or at about 150° C. to about 155° C.); or a combination thereof; (ii) preparing the second mixture includes, consists essentially of, or consists of: combining the first mixture, the at least one of the one or more filler, and the at least one of the one or more plasticizer; combining at a temperature of about 75° C. to about 90° C. (e.g., about 82° C.); mixing/sweeping the second mixture at a temperature of about 100° C. to about 115° C. (e.g., about 110° C.); holding the third mixture at a temperature of about 130° C. to about 145° C. (e.g., holding the second mixture for about 2 to 8 minutes or about 2 to about 5 minutes, and/or at about 138° C.); or a combination thereof; (iii) preparing the third mixture includes, consists essentially of, or consists of: combining (e.g., sandwiching in) the second mixture, the at least one of one or more vulcanizing accelerator, the at least one of the one or more coupling agent, the one or more cross-linking or vulcanizing agent, or a combination thereof; mixing/sweeping the third composition at a temperature of about 75° C. to about 110° C. (e.g., about 80° C. to about 105° C.); or a combination thereof; or (iv) a combination thereof.

Another aspect of the present disclosure provides a tire (e.g., a silica compounded tire) comprising, consisting essentially of, or consisting of, the additive composition (e.g., an additive composition for silica compounded rubber composition) of the present disclosure, the rubber composition of the present disclosure, or a rubber composition prepared according to the method of the present disclosure.

In any aspect or embodiment described herein, the tire further comprises, consists essentially of, or consists of, a framework or structural reinforcements.

In any aspect or embodiment described herein, the framework or structure reinforcements include a metal (e.g., steel fibers/cords, brass coated steel fibers/cords, or a combination thereof), a textile/fabric (e.g., synthetic textile/fabric (such as, polyester textile/fabric, nylon textile/fabric, rayon textile/fabric, aramid textile/fabric, or a combination thereof), a natural textile/fabric (such as, cotton textile/fabric, silk textile/fabric, or a combination thereof), or a combination thereof), or a combination thereof.

The preceding general areas of utility are given by way of example only and are not intended to be limiting on the scope of the present disclosure and appended claims. Additional objects and advantages associated with the polymers, compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

To meet the demands for electric vehicles (EVs) for weight distribution and effective range, technology development has focused on the development of low rolling resistance (LRR) tires with the major differentiating factor between conventional tires being the use of silica in the low roll resistance (LRR) tires. Additionally, some countries are posing regulatory requirements to monitor and quantify small particle emissions from tires as a result of abrasion or wear, thereby dramatically increasing the importance of these properties in tire performance. Thus, there is a need in the tire industry for tire compounding additives that will enhance rubber and thus tire performance/properties. The present disclosure provides an additive composition that enhances the properties of silica compounded rubber compositions, including increasing silica dispersion and decreasing Payne Effect of the formulated silica compounded rubber compositions, while maintaining the Mooney viscosity, Mooney scorch, hardness, tensile strength, elongation/strain, abrasion resistance, and modulus of the silica compounded rubber in acceptable ranges. The silica compounded rubber of the present disclosure surprisingly and unexpectedly has increased/stronger fuel economy, enhanced/stronger winter traction, enhanced/stronger dry traction, and enhanced/stronger dry handling.

The inventors of the present disclosure have surprisingly and unexpected discovered that additive composition of the present disclosure enhances the properties of silica compounded rubber, including increasing silica dispersion and decreasing Payne Effect of the formulated silica compounded rubber, while maintaining the Mooney viscosity, Mooney scorch, hardness, tensile strength, elongation/strain, abrasion resistance, and modulus of the silica compounded rubber in acceptable ranges. The silica compounded rubber of the present disclosure surprisingly and unexpectedly has increased/stronger fuel economy, enhanced/stronger winter traction, enhanced/stronger dry traction, and enhanced/stronger dry handling.

Thus, the present disclosure provides an additive composition for a silica compounded rubber compositions, wherein the additive composition (e.g., an additive composition for a silica compounded rubber composition) is made by a process comprising, consisting essentially of, or consisting of, reacting (A) a fatty acid composition with (B) a unsubstituted or substituted, linear or branched polyalkylpolyamine (e.g., a linear polyalkylpolyamine that is optionally substituted with one or more methyl groups). In any aspect or embodiment described herein, the additive composition comprises, consists essentially of, or consists of: diethylenetriamine (DETA) oleic acid amidoamine, diethylenetriamine (DETA) oleic acid imidazoline, diethylenetriamine (DETA) oleic acid bisamide, triethylenetetramine (TETA) oleic acid amidoamine, tetraethylenepentamine (TEPA) oleic acid amidoamine, dimethylaminopropylamine (DMAPA) oleic acid amidoamine, or a combination thereof. The present disclosure further provides a rubber composition (e.g., a silica compounded rubber composition) and a tire (e.g., a silica compounded tire) comprising the additive composition of the present disclosure.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value in the range, to the tenth of the unit of the lower limit unless the context clearly dictates otherwise (for example, in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either/or both of those included limits are also included in the disclosure.

It should also be understood that, in certain methods or processes described herein that include more than one step or act, the order of the steps or acts of the method is not necessarily limited to the order in which the steps or acts of the method are recited unless the context indicates otherwise.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (that is, to at least one or one or more of) of the grammatical object of the article unless the context clearly indicates otherwise. By way of example, “an element” means one element or more than one element, unless otherwise indicated.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, that is, “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (that is, “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended (that is, to mean including but not limited to). It is expressly contemplated that all embodiments, and claims reciting one of the open-ended transitional phrases can be written with any other transitional phrase, which may be more limiting, unless clearly precluded by the context or art. Only the transitional phrases “consisting of” and “consisting essentially of” shall be closed or semi-closed transitional phrases, respectively, as set forth in the United States Patent Office Manual of Patent Examining Procedures, Section 2111.03.

The term “independently” is used herein to indicate that the variable, which is independently applied, varies independently from application to application.

The term “effective” is used to describe an amount of a compound, composition or component which, when used within the context of its intended use, effects an intended result. The term effective subsumes all other effective amount or effective concentration terms, which are otherwise described or used in the present application.

### Additive Composition

As discussed herein, the inventors of the present disclosure surprisingly and unexpected discovered that the additive composition of the present disclosure enhances the properties of silica compounded rubbers, including increasing silica dispersion and decreasing Payne Effect of the formulated silica compounded rubber, while maintaining the Mooney viscosity, Mooney scorch, hardness, tensile strength, elongation/strain, abrasion resistance, and modulus of the silica compounded rubber in acceptable ranges. Furthermore, a tire comprising a silica compounded rubber of the present disclosure surprisingly and unexpectedly also has increased/stronger fuel economy, enhanced/stronger winter traction, enhanced/stronger dry traction, and enhanced/stronger dry handling.

An aspect of the present disclosure provides an additive composition (e.g., an additive composition for a silica compounded rubber composition) made by a process comprising, consisting essentially of, or consisting of, reacting (A) a fatty acid composition with (B) a unsubstituted or substituted, linear or branched polyalkylpolyamine (e.g., a linear polyalkylpolyamine that is optionally substituted with one or more methyl groups).

In any aspect or embodiment described herein, (i) the fatty acid composition includes or is oleic acid, stearic acid, palmitic acid, linoleic acid, linolenic acid, isostearic acid, ricolenic acid, a natural fatty acid mixture, crude tall oil (CTO), distilled tall oil, tall oil fatty acids (TOFA, such as Type I TOFA, Type II TOFA, Type II TOFA, or a combination thereof), vegetable oil, soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof; (ii) the unsubstituted or substituted, linear or branched polyalkylpolyamine includes or is diethylenetriamine (DETA), dimethylaminopropylamine (DMAPA), triethylenetetramine (TETA), tetraethylenepentamine (TEPA), or a mixture thereof; or (iii) a combination thereof.

In any aspect or embodiment described herein, (i) the fatty acid composition includes or is oleic acid, stearic acid, palmitic acid, linoleic acid, linolenic acid, isostearic acid, ricolenic acid, or a mixture thereof; (ii) the unsubstituted or substituted, linear or branched polyalkylpolyamine includes or is diethylenetriamine (DETA), dimethylaminopropylamine (DMAPA), or a mixture thereof; or (iii) a combination thereof.

In any aspect or embodiment described herein, (i) the fatty acid composition includes or is oleic acid; (ii) the unsubstituted or substituted, linear or branched polyalkylpolyamine includes or is diethylenetriamine (DETA); or (iii) a combination thereof.

In any aspect or embodiment described herein, the additive composition includes, consists essentially of, or consists of, one or more (e.g., 1, 2, 3, 4, 5, or more) compound with the chemical structure:

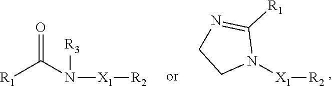

wherein:
X₁ has the chemical structure

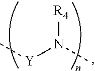

wherein n is an integer from 1, 2, 3, 4, or 5;
X₂ has the chemical structure

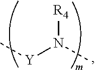

wherein m is an integer from 1, 2, 3, 4, or 5;
Y is a C₁₋₄ hydrocarbon chain;
R₁ is a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups;
R₂ is a hydrogen, a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups, or

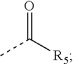

R₃ is a hydrogen or a C₁₋₆ linear or branched alkyl;
each R₄ is a hydrogen or a C₁₋₆ linear or branched alkyl; and
R₅ is a C₈₋₃₆ hydrocarbon chain with 1, 2, or 3 degrees of unsaturation (e.g., a C₈₋₂₂ hydrocarbon chain with 1, 2, or 3 degrees of unsaturation or a C₈₋₂₂ or C₈₋₁₈ hydrocarbon chain with 1 or 2 degrees of unsaturation), optionally 1, or 2 carbonyl groups and/or carboxylic groups.

In any aspect or embodiment described herein, R₂ is a hydrogen, C₈₋₃₆, C₈₋₂₂, or C₈₋₁₈ hydrocarbon chain with 0, 1, or 2 degrees of unsaturation (e.g., C₈₋₃₆, C₈₋₂₂, or C₈₋₁₈ hydrocarbon chain with 1 or 2 degrees of unsaturation) and optionally 1 or 2 carbonyl groups and/or carbocyclic groups, or

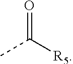

In any aspect or embodiment described herein, R₂ is a hydrogen or C₈₋₃₆, C₈₋₂₂, or C₈-18 hydrocarbon chain with 0, 1, or 2 degrees of unsaturation (e.g., C₈₋₃₆, C₈₋₂₂, or C₈₋₁₈ hydrocarbon chain with 1 or 2 degrees of unsaturation) and optionally 1 or 2 carbonyl groups and/or carbocyclic groups.

In any aspect or embodiment described herein, R₂ is a hydrogen, C₈₋₃₆, C₈₋₂₂, or C₈₋₁₈ hydrocarbon chain with 0 or 1 degrees of unsaturation (e.g., C₈₋₂₂ or C₈₋₁₈ hydrocarbon chain with 0 or 1 degrees of unsaturation) and optionally 1 or 2 carbonyl groups and/or carbocyclic groups, or

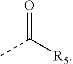

In any aspect or embodiment described herein, R₂ is a hydrogen, C₈₋₂₂ or C₈₋₁₈ hydrocarbon chain with 1, 2, or 3 degrees of unsaturation, or

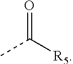

In any aspect or embodiment described herein, R₂ is a hydrogen or

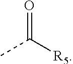

In any aspect or embodiment described herein, R₅ is a C₈₋₂₂ or C₈₋₁₈ hydrocarbon chain with 0, 1, or 2 degrees of unsaturation (e.g., a C₈₋₂₂ or C₈₋₁₈ hydrocarbon chain with 0 or 1 degree of unsaturation).

In any aspect or embodiment described herein, R₅ is a C₈₋₂₂ or C₈₋₁₈ hydrocarbon chain with 1 or 2 degrees of unsaturation (e.g., a C₈₋₂₂ or C₈₋₁₈ hydrocarbon chain with 1 degree of unsaturation).

In any aspect or embodiment described herein, the additive composition comprises, consists essentially of, or consists of: diethylenetriamine (DETA) oleic acid amidoamine, diethylenetriamine (DETA) oleic acid imidazoline, diethylenetriamine (DETA) oleic acid bisamide, triethylenetetramine (TETA) oleic acid amidoamine, tetraethylenepentamine (TEPA) oleic acid amidoamine, dimethylaminopropylamine (DMAPA) oleic acid amidoamine, or a combination thereof.

In any aspect or embodiment described herein, the additive composition comprises, consists essentially, or consists of, diethylenetriamine (DETA) oleic acid amidoamine.

In any aspect or embodiment described herein, the additive composition comprises, consists essentially, or consists of, diethylenetriamine (DETA) oleic acid imidazoline.

In any aspect or embodiment described herein, the additive composition comprises, consists essentially, or consists of, diethylenetriamine (DETA) oleic acid bisamide, triethylenetetramine (TETA) oleic acid amidoamine.

In any aspect or embodiment described herein, the additive composition comprises, consists essentially, or consists of, tetraethylenepentamine (TEPA) oleic acid amidoamine. dimethylaminopropylamine (DMAPA) oleic acid amidoamine.

In any aspect or embodiment described herein, the additive composition comprises, consists essentially, or consists of,

In any aspect or embodiment described herein, the additive composition comprises, consists essentially, or consists of: diethylenetriamine (DETA) oleic acid amidoamine, diethylenetriamine (DETA) oleic acid bisamide, or a combination thereof.

### Fatty Acid Composition

Crude tall oil (CTO) is a by-product obtained from the Kraft pulping process of coniferous trees. CTO is a valuable source of fatty acids, rosin acids, and unsaponifiables or neutral components such as phytosterols. The composition of the chemical components in CTO varies geographically as well as with the coniferous tree species used in the Kraft pulping process. CTO is distilled to produce tall oil fractions such as heads, tall oil fatty acids (TOFA), distilled tall oil (DTO), tall oil rosin (TOR), and tall oil pitch. Pine tree-derived TOR contains several C20 acid isomers including abietic, dehydroabictic, and pimaric acids. TOFA comprises primarily C18 linear saturated and unsaturated chains, for example, linoleic acid, oleic acid, and linolenic acid.

The kraft pulping process is utilized to convert wood into wood pulp, wherein crude tall oil (CTO) is produced as a byproduct. Crude tall oil can be upgraded through distillation to produce rosin-rich distillates and distilled tall oil. Distillation streams produce tall oil pitch (TOP), tall oil rosin (TOR), head streams (light ends), tall oil fatty acids (TOFA), and distilled tall oil (DTO). Pine tree-derived TOR contains several C20 acid isomers including abietic, dehydroabietic, and pimaric acids. TOFA comprises primarily C18 linear saturated and unsaturated chains (for example, linoleic acid, oleic acid, and linolenic acid). The principle composition and yields of tall oil fractions and some empirical volatility data is provided in Table 1, and exemplary data and composition of some crude tall oil is provided in Table 2 and some tall oil fatty acids are provided in Table 3.

TABLE 1
Composition and Yields of Tall Oil Fractions
and Empirical Volatility Data*

| | Yield | Acid | Composition (%) | | |
|---|---|---|---|---|---|
| | (%) | Number | Rosin Acids | Fatty Acids | Neutrals |
| Head, light ends | 5-12 | 70-120 | <0.5 | 30-50 | 40-60 |
| Tall Oil Fatty | 35-45 | 192-197 | <2 | 95-98 | 1-2 |
| Acids | | | | | |
| Distilled Tall Oil | 5-15 | 180-190 | 20-30 | 65-70 | 4-7 |
| Tall Oil Rosin | 20-35 | 165-182 | 85-96 | 1-5 | 1-7 |
| Tall Oil Pitch | 20-40 | 20-50 | 5-13 | 5-10 | 40-60 |

*Adapted from Table 6 of Norlin, H., et al., Ullmann's Encyclopedia of Industrial Chemistry. Volume 35, pages 583-596 (Tall Oil). 7^{th} Edition. 2012.

TABLE 2
Exemplary Data and Composition of Crude Tall Oil*

| | Scandinavia | United States | Canada | |
|---|---|---|---|---|
| | (typical mix) | (pine) | (mixed) | France |
| Acid Number | 145 | 165 | 140 | 165 |
| Saponification | 160 | 172 | 165 | 172 |
| Number | | | | |
| Fatty Acids (%) | 45 | 45 | 42 | 40 |
| Palmitic (16:0) | 1.5 | 3 | 2 | 2 |
| Stearic (18:0) | 0.5 | 1 | 1 | 1 |
| Oleic (18:1) | 10 | 20 | 10 | 15 |
| Linoleic (18:2) | 17 | 13 | 15 | 11 |
| Pinolenic (18:3) | 5 | 1 | 3 | 1 |
| Arachidic (20:0) | 1 | 0.5 | 1 | 0.5 |
| Other | 10 | 6.5 | 10 | 9.5 |
| Rosin Acids (%) | 30 | 42 | 30 | 50 |
| Pimaric | 2 | 3 | 2 | 5 |
| Palustric | 4 | 7 | 5 | 7 |
| Isopimaric | 2 | 4 | 4 | 4 |
| Abietic | 12 | 15 | 10 | 18 |
| Dehydroabietic | 5 | 4 | 4 | 5 |
| Neoabietic | 4 | 6 | 3 | 6 |
| Others | 1 | 3 | 2 | 5 |
| Neutrals (%) | 25 | 13 | 28 | 10 |

| | |
|---|---|
| Moisture | <2% |
| Ash | <0.2% |
| Mineral Acid (H₂SO₄) | <0.02% |
| Sulfur | <0.03% |

*Adapted from Table 3 of Norlin, H., et al., Ullmann's Encyclopedia of Industrial Chemistry. Volume 35, pages 583-596 (Tall Oil). 7^{th} Edition. 2012.

TABLE 3
Exemplary Data and Composition of Tall Oil Fatty Acids*

| | Scandinavia | United States |
|---|---|---|
| Acid Number | 195 | 197 |
| Rosin Acid (%) | 2 | 1 |
| Unsaponifiables (%) | 2 | 1.5 |
| Iodine Value | 150 | 130 |
| Color, Garner | 4 | 3 |
| Fatty Acids (%) | | |
| Saturated | 2 | 2 |
| Oleic (18:1) | 30 | 48 |
| Linoleic (18:2) | 44 | 37 |
| Linolenic (18:3) | 10 | 3 |
| Conjugated (18:2) | 6 | 6 |
| Other | 4 | 2.5 |

*Adapted from Table 7 of Norlin, H., et al., Ullmann's Encyclopedia of Industrial Chemistry. Volume 35, pages 583-596 (Tall Oil). 7^{th} Edition. 2012.

TOFA is further broken down into Type I (minimum of 98% fatty acids and a maximum of 1% rosin acids), Type II (minimum of 96% fatty acids and a maximum of 2% rosin acids), and Type III (minimum of 90% fatty acids and a maximum of 10% rosin acids), as shown in Table 4, depending upon acid value, rosin acids concentration, unsaponifiables concentration, fatty acids concentration, Gardner color, and iodine value.

TABLE 4
Tall Oil Fatty Acids Requirements*

| | | Type I | | Type II | | Type III | |
|---|---|---|---|---|---|---|---|
| | Method | Min | Max | Min | Max | Min | Max |
| Acid Value | ASTM D1980 | 197 | — | 192 | — | 190 | — |
| Rosin Acids (%) | ASTM D1240 | — | 1.0 | — | 2.0 | — | 10.0 |
| Unsaponifiables (%) | ASTM D1965 | — | 1.0 | — | 2.0 | — | 10.0 |
| Fatty Acids (%) | ASTM D1983 | 98 | — | 96 | — | 90 | — |
| Color, Gardner | ASTM D1544 | — | 4 | — | 5 | — | 10.0 |
| Iodine Value | ASTM D1959 | 125 | 135 | — | — | — | — |

*Adapted from Table 1 of American Society for Testing and Materials (ASTM): D1984-69 (Standard Specification for Tall Oil Fatty Acids).

The standard methods recited in Table 4 can be utilized to determine the acid number, rosin acid concentration (%), unsaponifiables concentration (%), fatty acids concentration (%), Gardner color, and iodine value of fatty acid compositions.

The fatty acid composition of sixteen exemplary vegetable oils, determined by gas chromatography, is shown in Table 5.

TABLE 5
Exemplary Data and Composition of Sixteen Exemplary Vegetable Oils*^{†}

| FAS [%] | SAF | GRP | SIL | HMP | SFL | WHG | PMS | SES | RB | ALM | RPS | PNT | OL | COC | TA | CO |
|---|---|---|---|---|---|---|---|---|---|---|---|---|---|---|---|---|
| C6:0 | ND | ND | ND | ND | ND | ND | ND | ND | ND | ND | ND | ND | ND | 0.52 | ND | ND |
| C8:0 | ND | 0.01 | ND | ND | ND | ND | ND | ND | ND | ND | ND | ND | ND | 7.6 | ND | ND |
| C10:0 | ND | ND | ND | ND | ND | ND | ND | ND | ND | ND | 0.01 | ND | ND | 5.5 | ND | ND |
| C12:0 | ND | 0.01 | 0.01 | ND | 0.02 | 0.07 | ND | ND | ND | 0.09 | ND | ND | ND | 47.7 | 0 | 0 |
| C14:0 | 0.10 | 0.05 | 0.09 | 0.07 | 0.09 | ND | 0.17 | ND | 0.39 | 0.07 | ND | 0.04 | ND | 19.9 | 4 | 1 |
| C15:0 | ND | 0.01 | 0.02 | ND | ND | 0.04 | ND | ND | ND | ND | 0.02 | ND | ND | ND | ND | ND |
| C16:0 | 6.7 | 6.6 | 7.9 | 6.4 | 6.2 | 17.4 | 13.1 | 9.7 | 20.0 | 6.8 | 4.6 | 7.5 | 16.5 | ND | 28 | 3 |
| C17:0 | 0.04 | 0.06 | 0.06 | 0.05 | 0.02 | 0.03 | 0.13 | ND | ND | 0.05 | 0.04 | 0.07 | ND | ND | ND | ND |
| C18:0 | 2.4 | 3.5 | 4.5 | 2.6 | 2.8 | 0.7 | 5.7 | 6.5 | 2.1 | 2.3 | 1.7 | 2.1 | 2.3 | 2.7 | 23 | 2 |
| C20:0 | ND | 0.16 | 2.6 | ND | 0.21 | ND | 0.47 | 0.63 | ND | 0.09 | ND | 1.01 | 0.43 | ND | ND | ND |
| C22:0 | ND | ND | ND | ND | ND | ND | ND | 0.14 | ND | ND | ND | ND | 0.15 | ND | ND | ND |
| C16:1 (n-7) | 0.08 | 0.08 | 0.05 | 0.11 | 0.12 | 0.21 | 0.12 | 0.11 | 0.19 | 0.53 | 0.21 | 0.07 | 1.8 | ND | ND | ND |
| C17:1 (n-7) | ND | ND | 0.03 | ND | ND | ND | ND | ND | ND | ND | ND | ND | ND | ND | ND | ND |
| C18:1 (n-9) | ND | ND | ND | ND | ND | ND | ND | ND | ND | ND | ND | ND | ND | ND | 35 | 58 |
| C18:1cis (n-9) | 11.5 | 14.3 | 20.4 | 11.5 | 28.0 | 12.7 | 24.9 | 41.5 | 42.7 | 67.2 | 63.3 | 71.1 | 66.4 | 6.2 | ND | ND |
| C18:1trans (n-9) | ND | ND | ND | ND | ND | ND | ND | ND | ND | ND | 0.14 | ND | ND | ND | ND | ND |
| FAs [%] | SAF | GRP | SIL | HMP | SFL | WHG | PMS | SES | RB | ALM | RPS | PNT | OL | COC | TA | CO |
| C20:1(n-9) | ND | 0.40 | 0.15 | 16.5 | 0.18 | 7.91 | 1.08 | 0.32 | 1.11 | 0.16 | 9.1 | ND | 0.30 | ND | ND | ND |
| C18:2cis (n-6) | 79.0 | 74.7 | 63.3 | 59.4 | 62.2 | 59.7 | 54.2 | 40.9 | 33.1 | 22.8 | 19.6 | 18.2 | 16.4 | 1.6 | 2 | 9 |
| C18:3 | ND | ND | ND | ND | ND | ND | ND | ND | ND | ND | ND | ND | ND | ND | 1 | 23 |
| C18:3 (n-3) | 0.15 | 0.15 | 0.88 | 0.36 | 0.16 | 1.2 | 0.12 | 0.21 | 0.45 | ND | 1.2 | ND | 1.6 | ND | ND | ND |
| C18:3 (n-6) | ND | ND | ND | 3.0 | ND | ND | ND | ND | ND | ND | ND | ND | ND | ND | ND | ND |
| SFAS | 9.3 | 10.4 | 15.1 | 9.2 | 9.4 | 18.2 | 19.6 | 16.9 | 22.5 | 9.3 | 6.3 | 10.7 | 19.4 | 92.1 | ND | ND |
| MUFAS | 11.6 | 14.8 | 20.7 | 28.1 | 28.3 | 20.9 | 26.1 | 42.0 | 44.0 | 67.9 | 72.8 | 71.1 | 68.2 | 6.2 | ND | ND |
| PUFAS | 79.1 | 74.9 | 64.2 | 62.8 | 62.4 | 61.0 | 34.3 | 41.2 | 33.6 | 22.8 | 20.9 | 18.2 | 18.0 | 1.6 | ND | ND |
| n-3 PUFAS | 0.2 | 0.2 | 0.9 | 0.4 | 0.2 | 1.2 | 0.1 | 0.2 | 0.5 | 0.0 | 1.2 | 0.0 | 1.6 | 0.0 | ND | ND |
| n-6 PUFAS | 79.0 | 74.7 | 63.3 | 62.4 | 62.2 | 59.7 | 54.2 | 40.9 | 33.1 | 22.8 | 19.6 | 18.2 | 16.4 | 1.6 | ND | ND |

*Data are expressed as percentages of total fatty acid methyl esters (FAMEs); ND means that FAs was not determined.
Abbreviations of the samples mean: SFA—saturated fatty acids, MUFA—monounsaturated fatty acids, PUFA—polyunsaturated fatty acids, SAF—safflower oil, GRP—grapeseed oil, SIL—silybum marianum (thistle oil), HMP—hemp oil, SFL—sunflower oil, WHG—wheat germ oil, PMS—pumpkin seed oil, SES—sesame oil, RB—rice bran oil, ALM—almond oil, RPS—rapeseed oil, PNT—peanut oil, OL-olive oil, COC—coconut oil, TA—tallow oil, and CA—canola oil.
^{†}Adapted from Table 1 of Orsavova, J., et al., Int. J. Mol. Sci. 2015. 16: 12871-12890.

In any aspect or embodiment described herein, the fatty acid composition includes or is oleic acid, stearic acid, palmitic acid, linoleic acid, linolenic acid, isostearic acid, ricolenic acid, a natural fatty acid mixture, crude tall oil (CTO), distilled tall oil, tall oil fatty acids (TOFA, such as Type I TOFA, Type II TOFA, Type II TOFA, or a combination thereof), vegetable oil, soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof.

In any aspect or embodiment described herein, the fatty acid composition includes or is oleic acid, stearic acid, palmitic acid, linoleic acid, linolenic acid, isostearic acid, ricolenic acid, or a mixture thereof

In any aspect or embodiment described herein, the fatty acid composition includes or is oleic acid.

### Poly(alkyl)amine

In any aspect or embodiment described herein, the unsubstituted or substituted, linear or branched polyalkylpolyamine includes or is diethylenetriamine (DETA), dimethylaminopropylamine (DMAPA), triethylenetetramine (TETA), tetraethylenepentamine (TEPA), or a mixture thereof.

In any aspect or embodiment described herein, the unsubstituted or substituted, linear or branched polyalkylpolyamine includes or is diethylenetriamine (DETA), dimethylaminopropylamine (DMAPA), or a mixture thereof.

In any aspect or embodiment described herein, the unsubstituted or substituted, linear or branched polyalkylpolyamine includes or is diethylenetriamine (DETA).

### Use of the Additive Composition

A further aspect of the present disclosure provides the use of the additive composition of the present disclosure in a rubber. In any aspect or embodiment described herein, the use of the additive composition of the present disclosure is in a rubber composition. In any aspect or embodiment described herein, the use of the additive composition of the present disclosure is in a silica compounded rubber composition.

Another aspect of the present disclosure provides the use of the additive composition of the present disclosure in a tire. In any aspect or embodiment described herein, the use of the additive composition of the present disclosure is in a silica compounded tire.

### Rubber Composition

An additional aspect of the present disclosure provides a rubber composition comprising, consisting essentially of, or consisting of: the additive composition (e.g., an additive composition for a silica compounded rubber composition) of the present disclosure; one or more (e.g., 1, 2, 3, 4, 5, 6, or more) elastomer (e.g. one or more functionalized elastomer); and one or more (e.g., 1, 2, 3, 4, 5, 6, or more) filler (e.g., a reinforcing filler) that includes silica (e.g., fumed silica, precipitated silica, pre-treated precipitated silica, silicon dioxide, zeolites, clays (e.g., kaolinite), silicate minerals, inorganic silicate, or a combination thereof).

In any aspect or embodiment described herein, the rubber composition further comprises, consists essentially of, or consists of: (a) one or more (e.g., 1, 2, 3, 4, 5, 6, or more) plasticizer; (b) one or more (e.g., 1, 2, 3, 4, 5, 6, or more) coupling agent (e.g., an organosilane or sulfur functional organosilanes); or (c) a combination thereof.

In any aspect or embodiment described herein, the rubber composition further comprising, consisting essentially of, or consisting of: (a) one or more (e.g., 1, 2, 3, 4, 5, 6, or more) antiaging agent (e.g., an antioxidant, an antiozonant, or a combination thereof); (b) one or more (e.g., 1, 2, 3, 4, 5, 6, or more) vulcanization accelerator (e.g., a sulfonamide-based accelerator); or (c) a combination thereof.

In any aspect or embodiment described herein, (a) the rubber further comprises, consisting essentially of, or consisting of, one or more (e.g., 1, 2, 3, 4, 5, 6, or more) cross-linking or vulcanization agent (e.g. sulfur); (b) the one or more vulcanization accelerator include a sulfenamide-based accelerator (e.g., N-tert-butyl-benzothiazole sulfonamide (TBBS)); (c) the one or more coupling agent further includes diphenyl guanidine (DPG) (e.g., oxybispropanol, mixture of structural isomers of oxybispropanol; 1,1′-oxybis-2-propanol; 2,2′-oxybis-1-propanol; 2-(2-hydroxypropoxy)-1-propanol; or a mixture thereof); or (d) a combination thereof.

In any aspect or embodiment described herein, the additive composition is present in an amount of about 1 to about 10 PHR (e.g., about 1 to about 8 PHR, about 1 to about 5 PHR, about 2 to about 4 PHR or about 3 PHR).

### Elastomer(s)

In any aspect or embodiment described herein, the compositions of the present disclosure (e.g., rubber, rubber composition, silica compounded rubber composition, tire, a silica compounded tire, etc.) includes one or more (e.g., 1, 2, 3, 4, 5, 6, or more) elastomer (e.g., rubber). In any aspect or embodiment described herein, each of the one or more elastomer is a rubber (e.g., a diene-based rubber, a natural diene-based rubber, a synthetic diene-based rubber, or a mixture thereof). In any aspect or embodiment described herein, the one or more elastomer includes one or more (e.g., 1, 2, 3, 4, 5, 6, or more) natural rubber, one or more (e.g., 1, 2, 3, 4, 5, 6, or more) synthetic rubber, or a combination thereof. In any aspect or embodiment described herein, the one or more elastomer includes a synthetic rubber that includes one or more diene-based rubber. In any aspect or embodiment described herein, the one or more elastomer includes a natural rubber that includes one or more diene-based rubber.

In any aspect or embodiment described herein, the one or more elastomer or rubber includes or is a natural diene-based rubber, a synthetic diene-based rubber (e.g., polybutadiene rubber (BR), synthetic polyisoprene rubber (IR), styrene-butadiene copolymer rubber (SBR), styrene-isoprene copolymer rubber (SIR), etc.), or a combination thereof. In any aspect or embodiment described herein, the one or more elastomer/rubber includes or is a blend of diene-based rubbers (e.g., a natural diene-based rubber, a synthetic diene-based rubber, or a combination thereof). In any aspect or embodiment described herein, the diene-based rubbers (e.g., a natural diene-based rubber, a synthetic diene-based rubber, or a combination thereof) includes or is a modified diene-based rubber or an unmodified diene-based rubber.

In any aspect or embodiment described herein, the one or more elastomer includes a sulfur and/or peroxide vulcanizable one or more (e.g., 1, 2, 3, 4, 5, 6, or more) natural elastomer, one or more (e.g., 1, 2, 3, 4, 5, 6, or more) synthetic elastomer, or combinations thereof. In any aspect or embodiment described herein, the one or more elastomer includes or is a conjugated diene-based elastomer (e.g., polybutadiene rubber, high-cis polybutadiene rubber (e.g., high cis-1,4-polybutadiene, high cis-1,4-polybutadiene stabilized with a non-staining antioxidant), and high-vinyl polybutadiene rubber), polyisoprene, natural rubber, isoprene-butadiene copolymer, emulsion-polymerized styrene-butadiene rubber, and solution-polymerized styrene-butadiene rubber (e.g., low-vinyl, mid-vinyl, and/or high-vinyl solution-polymerized styrene-butadiene rubber, a styrene-butadiene copolymer rubber (e.g., solution styrene-butadiene rubber), or a combination thereof). In any aspect or embodiment described herein, the conjugated diene-based elastomer is a sulfur-vulcanizable elastomer containing olefinic unsaturation, or a combination of such elastomers.

In any aspect or embodiment described herein, the one or more elastomer includes a synthetic rubber that includes one or more diene-based rubber that includes a styrene-butadiene copolymer rubber (e.g., solution styrene-butadiene rubber), a polybutadiene (e.g., high cis-1,4-polybutadiene, high cis-1,4-polybutadiene stabilized with a non-staining antioxidant), or a combination thereof.

In any aspect or embodiment described herein, the one or more elastomer includes a functionalized elastomer (e.g., a tin, silicon, and/or amine coupled elastomer, terminated elastomer, or coupled and terminated elastomer). For example, in any aspect or embodiment described herein, the functionalized elastomer is an organic solution polymerization prepared with tin, silicon, and/or amine coupled and/or terminated to elastomers (e.g., a conjugated diene-based elastomer (e.g., polybutadiene rubber, high-cis polybutadiene rubber (e.g., high cis-1,4-polybutadiene, high cis-1,4-polybutadiene stabilized with a non-staining antioxidant), and high-vinyl polybutadiene rubber), polyisoprene, natural rubber, isoprene-butadiene copolymer, emulsion-polymerized styrene-butadiene rubber, and solution-polymerized styrene-butadiene rubber (e.g., low-vinyl, mid-vinyl, and/or high-vinyl solution-polymerized styrene-butadiene rubber, a styrene-butadiene copolymer rubber (e.g., solution styrene-butadiene rubber), or a combination thereof)). In any aspect or embodiment described herein, the one or more elastomer or functional elastomer includes or is a tin, silicon, and/or amine coupled styrene/butadiene copolymer. Tin and silicon coupled copolymers of styrene/butadiene may be prepared, for example, by introducing a tin, silicon, and/or amine functional group or monomer.

In any aspect or embodiment described herein, the synthetic rubber is present in an amount of at least 50 parts per hundred of rubber (PHR) (e.g., at least 75 PHR, at least 80 PHR, at least 85 PHR, at least 90 PHR, at least 95 PHR, at least 98 PHR, at least 99 PHR, or 100 PHR). For example, in any aspect or embodiment described herein, the synthetic rubber is present in an amount of about 50 to 100 PHR, about 50 to 95 PHR, about 50 to 90 PHR, about 50 to 85 PHR, about 50 to 80 PHR, about 50 to 75 PHR, about 50 to 70 PHR, about 50 to 65 PHR, about 50 to 60 PHR, about 50 to 55 PHR, about 55 to 100 PHR, about 55 to 95 PHR, about 55 to 90 PHR, about 55 to 85 PHR, about 55 to 80 PHR, about 55 to 75 PHR, about 55 to 70 PHR, about 55 to 65 PHR, about 55 to 60 PHR, about 60 to 100 PHR, about 60 to 95 PHR, about 60 to 90 PHR, about 60 to 85 PHR, about 60 to 80 PHR, about 60 to 75 PHR, about 60 to 70 PHR, about 60 to 65 PHR, about 65 to 100 PHR, about 65 to 95 PHR, about 65 to 90 PHR, about 65 to 85 PHR, about 65 to 80 PHR, about 65 to 75 PHR, about 65 to 70 PHR, about 70 to 100 PHR, about 70 to 95 PHR, about 70 to 90 PHR, about 70 to 85 PHR, about 70 to 80 PHR, about 70 to 75 PHR, about 75 to 100 PHR, about 75 to about 95 PHR, about 75 to about 90 PHR, about 75 to about 85 PHR, about 75 to about 80 PHR, about 80 to 100 PHR, about 80 to about 95 PHR, about 80 to about 90 PHR, about 80 to about 85 PHR, about 85 to 100 PHR, about 85 to about 95 PHR, about 85 to about 90 PHR, about 90 to 100 PHR, about 90 to about 95 PHR, about 95 to 100 PHR, about 95 to about 99 PHR, or 100 PHR.

In any aspect or embodiment described herein, the styrene butadiene copolymer rubber is present in an amount of about 60 to about 90 parts per hundred of rubber (PHR) (e.g., about 75 PHR). For example, in any aspect or embodiment described herein, the styrene butadiene copolymer rubber is present in an amount of about 60 to about 90 PHR, about 60 to about 85 PHR, about 60 to about 80 PHR, about 60 to about 75 PHR, about 60 to about 70 PHR, about 60 to about 75 PHR, about 65 to about 90 PHR, about 65 to about 85 PHR, about 65 to about 80 PHR, about 65 to about 75 PHR, about 65 to about 70 PHR, about 70 to about 90 PHR, about 70 to about 85 PHR, about 70 to about 80 PHR, about 70 to about 75 PHR, about 75 to about 90 PHR, about 75 to about 85 PHR, about 75 to about 80 PHR, about 80 to about 90 PHR, about 80 to about 85 PHR, or about 85 to about 90 PHR.

In any aspect or embodiment described herein, the polybutadiene is present in an amount of about 10 to about 40 PHR (e.g., about 25 PHR). For example, in any aspect or embodiment described herein, the polybutadiene is present in an amount of about 10 to about 40 PHR, about 10 to about 35 PHR, about 10 to about 30 PHR, about 10 to about 25 PHR, about 10 to about 20 PHR, about 10 to about 15 PHR, about 15 to about 40 PHR, about 15 to about 35 PHR, about 15 to about 30 PHR, about 15 to about 25 PHR, about 15 to about 20 PHR, about 20 to about 40 PHR, about 20 to about 35 PHR, about 20 to about 30 PHR, about 20 to about 25 PHR, about 25 to about 40 PHR, about 25 to about 35 PHR, about 25 to about 30 PHR, about 30 to about 40 PHR, about 30 to about 35 PHR, or about 35 to about 40 PHR.

### Filler(s)

In any aspect or embodiment described herein, a filler includes inorganic materials with surface hydroxyl/oxy groups (such as silica, precipitated silica, zeolites, clays (e.g., kaolinite), and silicate minerals).

In any aspect or embodiment described herein, the compositions of the present disclosure (e.g., rubber, rubber composition, silica compounded rubber composition, tire, a silica compounded tire, etc.) includes one or more (e.g., 1, 2, 3, 4, 5, 6, or more) filler (e.g., a reinforcing filler) that includes silica (e.g., fumed silica, precipitated silica, pre-treated precipitated silica, silicon dioxide, zeolites, clays (e.g., kaolinite), silicate minerals, inorganic silicate, or a combination thereof). Thus, in any aspect or embodiment described herein, the compositions of the present disclosure (e.g., rubber, rubber composition, silica compounded rubber composition, tire, a silica compounded tire, etc.) includes one or more (e.g., 1, 2, 3, 4, 5, 6, or more) silica filler (e.g., a reinforcing filler) that includes silica (e.g., fumed silica, precipitated silica, pre-treated precipitated silica, silicon dioxide, zeolites, clays (e.g., kaolinite), silicate minerals, inorganic silicate, or a combination thereof). In any aspect or embodiment described herein, the silica is silicon dioxide. In any aspect or embodiment described herein, the silica used is not specifically limited, and is exemplified as, silicon dioxide, pyrogenic silica, precipitated siliceous pigments (silica), precipitated high surface area (“HSA”), highly dispersive silica (“HDS”), wet silica (hydrous silicic acid), dry silica (anhydrous silicic acid), calcium silicate, aluminum silicate, etc., or a combination thereof. In any aspect or embodiment described herein, the silica is silicon dioxide (e.g., ZEOSIL® 1165, available from Solvay, Princeton, New Jersey). For example, in any aspect or embodiment described herein, a pre-treated silica includes or is a composite comprised of a precipitated silica pre-treated with a silica coupling agent prior to its introduction into the rubber composition. In any aspect or embodiment described herein, the silica includes one or more (1, 2, 3, 4, 5, 6, 7, or more) silica. In any aspect or embodiment described herein, a Brunauer-Emmett-Teller (BET) specific surface area of the silica (e.g., as measured using nitrogen gas, such as according to ISO 5794/1 (Rubber compounding ingredients—Silica, precipitated, hydrated—Part 1: Non-rubber tests), or Journal of the American Chemical Society, Volume 60, page 304 (1930)) is about 40 to about 600 m²/g.

For example, in any aspect or embodiment described herein, the BET specific surface area of the silica is about 40 to about 550 m²/g, about 40 to about 500 m²/g, about 40 to about 450 m²/g, about 40 to about 400 m²/g, about 40 to about 350 m²/g, about 40 to about 300 m²/g, about 40 to about 250 m²/g, about 40 to about 200 m²/g, about 40 to about 150 m²/g, about 100 to about 600 m²/g, about 100 to about 550 m²/g, about 100 to about 500 m²/g, about 100 to about 450 m²/g, about 100 to about 400 m²/g, about 100 to about 350 m²/g, about 100 to about 300 m²/g, about 100 to about 250 m²/g, about 100 to about 200 m²/g, about 150 to about 600 m²/g, about 150 to about 550 m²/g, about 150 to about 500 m²/g, about 150 to about 450 m²/g, about 150 to about 400 m²/g, about 150 to about 350 m²/g, about 150 to about 300 m²/g, about 150 to about 250 m²/g, about 200 to about 600 m²/g, about 200 to about 550 m²/g, about 200 to about 500 m²/g, about 200 to about 450 m²/g, about 200 to about 400 m²/g, about 200 to about 350 m²/g, about 200 to about 300 m²/g, about 250 to about 600 m²/g, about 250 to about 550 m²/g, about 250 to about 500 m²/g, about 250 to about 450 m²/g, about 250 to about 400 m²/g, about 250 to about 350 m²/g, about 300 to about 600 m²/g, about 300 to about 550 m²/g, about 300 to about 500 m²/g, about 300 to about 450 m²/g, about 300 to about 400 m²/g, about 350 to about 600 m²/g, about 350 to about 550 m²/g, about 350 to about 500 m²/g, about 350 to about 450 m²/g, about 400 to about 600 m²/g, about 400 to about 550 m²/g, about 400 to about 500 m²/g, about 450 to about 600 m²/g, about 450 to about 550 m²/g, or about 500 to about 600 m²/g. For example, in any aspect or embodiment described herein the silica has a BET specific surface area of about 40 to about 350 m²/g or about 80 to about 350 m²/g (e.g. about 120 to about 350 m²/g).

In any aspect or embodiment described herein, the one or more filler include one or more (e.g., 1, 2, 3, 4, 5, 6, or more) carbon black. In any aspect or embodiment described herein, the one or more carbon black is graded according to the American Society for Testing and Materials (ASTM) Committee D24 on Carbon Black nomenclature. In particular, carbon black grading starts with a “N” for normal curing material or an “S” for slow curing material, wherein most carbon black are now carry the prefix “N.” The first of three digits aver the “N” or “S” provides a course measurement of the mean particle diameter, in nanometers, of the carbon black, as determined by electron microscope. In particular, Table 6 below shows the digit associated with average particle size. Carbon black is further graded based on several additional criteria as shown below in Table 7.

TABLE 6
First Digit of the Carbon Black Nomenclature System

| Average Particle Size (nm) | First Digit Designation |
|---|---|
| 1-10 | 0 |
| 11-19 | 1 |
| 20-25 | 2 |
| 26-30 | 3 |
| 31-39 | 4 |
| 40-48 | 5 |
| 49-60 | 6 |
| 61-100 | 7 |
| 101-200 | 8 |
| 201-500 | 9 |

TABLE 7
Exemplary Testing Methods for Grading/Characterizing
of Carbon Black

| | ASTM | Range of | Lowest | Highest |
|---|---|---|---|---|
| | Method | Values | Black | Black |
| Particle Size | | | | |
| Iodine Adsorption | D1510 | 8-145 g/kg | N990 | N110 |
| Nitrogen Adsorption | D3037 | 8-143 m²/g | N990 | N110 |
| CTAB | D3765 | 8-132 m²/g | N990 | N121 |
| Structure | | | | |
| DBP Adsorption | D2414 | 43-150 cm³/100 g | N990 | N358 |
| DBP Compressed | D2493 | 42-112 cm³/g | N990 | N358 |
| Aggregate Size * | | | | |
| Tint Strength | D3265 | 17-125 tu | N990 | N234 |
| Surface Activity | | | | |
| Toluene Discoloration | D1618 | 98-75 | N351 | N110 |
| Pellet Properties | | | | |
| Crush Strength | D3313 | 20-80 5 | | |
| Fines Content | D1508 | 5-15% | | |
| Pelle Attrition | D4324 | 2-5% | | |
| Pour Density | D1513 | 18-40 lb/ft³ | N358 | N990 |

In any aspect or embodiment described herein, the one or more carbon black is a general purpose furnace (GPF) carbon black, a fast extruding furnace (FEF) carbon black (e.g., N550), a high abrasion furnace (HAF) carbon black (e.g., N330 carbon black), an intermediate super abrasion furnace (ISAF) carbon black (e.g., N220 carbon black), a super abrasion furnace (SAF) carbon black (e.g., N110 carbon black)), or a combination thereof. For example, in any aspect or embodiment described herein, the one or more carbon black is N330 carbon black, N234 carbon black, LH30 carbon black, N326 carbon black, N339 carbon black, N351 carbon black, N550 carbon black, N650 carbon black, N660 carbon black, or a mixture thereof. In any aspect or embodiment described herein, the one or more filler includes N330 carbon black.

In any aspect or embodiment described herein, the one or more filler is/are present in an amount of about 50 to about 150 PHR (e.g., about 50 to about 125 PHR, about 50 to about 100 PHR, about 72 to about 102 PHR, about 77 to about 97 PHR, or about 87 PHR). For example, in any aspect or embodiment described herein, the one or more filler is/are present in an amount of about 50 to about 150 PHR, about 50 to about 145 PHR, about 50 to about 140 PHR, about 50 to about 135 PHR, about 50 to about 130 PHR, about 50 to about 125 PHR, about 50 to about 120 PHR, about 50 to about 115 PHR, about 50 to about 110 PHR, about 50 to about 105 PHR, about 50 to about 100 PHR, about 50 to about 95 PHR, about 50 to about 90 PHR, about 50 to about 85 PHR, about 50 to about 80 PHR, about 50 to about 75 PHR, about 50 to about 70 PHR, about 50 to about 65 PHR, about 50 to about 60 PHR, about 50 to about 55 PHR, about 55 to about 150 PHR, about 55 to about 145 PHR, about 55 to about 140 PHR, about 55 to about 135 PHR, about 55 to about 130 PHR, about 55 to about 125 PHR, about 55 to about 120 PHR, about 55 to about 115 PHR, about 55 to about 110 PHR, about 55 to about 105 PHR, about 55 to about 100 PHR, about 55 to about 95 PHR, about 55 to about 90 PHR, about 55 to about 85 PHR, about 55 to about 80 PHR, about 55 to about 75 PHR, about 55 to about 70 PHR, about 55 to about 65 PHR, about 55 to about 60 PHR, about 60 to about 150 PHR, about 60 to about 145 PHR, about 60 to about 140 PHR, about 60 to about 135 PHR, about 60 to about 130 PHR, about 60 to about 125 PHR, about 60 to about 120 PHR, about 60 to about 115 PHR, about 60 to about 110 PHR, about 60 to about 105 PHR, about 60 to about 100 PHR, about 60 to about 95 PHR, about 60 to about 90 PHR, about 60 to about 85 PHR, about 60 to about 80 PHR, about 60 to about 75 PHR, about 60 to about 70 PHR, about 60 to about 65 PHR, about 65 to about 150 PHR, about 65 to about 145 PHR, about 65 to about 140 PHR, about 65 to about 135 PHR, about 65 to about 130 PHR, about 65 to about 125 PHR, about 65 to about 120 PHR, about 65 to about 115 PHR, about 65 to about 110 PHR, about 65 to about 105 PHR, about 65 to about 100 PHR, about 65 to about 95 PHR, about 65 to about 90 PHR, about 65 to about 85 PHR, about 65 to about 80 PHR, about 65 to about 75 PHR, about 65 to about 70 PHR, about 70 to about 150 PHR, about 70 to about 145 PHR, about 70 to about 140 PHR, about 70 to about 135 PHR, about 70 to about 130 PHR, about 70 to about 125 PHR, about 70 to about 120 PHR, about 70 to about 115 PHR, about 70 to about 110 PHR, about 70 to about 105 PHR, about 70 to about 100 PHR, about 70 to about 95 PHR, about 70 to about 90 PHR, about 70 to about 85 PHR, about 70 to about 80 PHR, about 70 to about 75 PHR, about 75 to about 150 PHR, about 75 to about 145 PHR, about 75 to about 140 PHR, about 75 to about 135 PHR, about 75 to about 130 PHR, about 75 to about 125 PHR, about 75 to about 120 PHR, about 75 to about 115 PHR, about 75 to about 110 PHR, about 75 to about 105 PHR, about 75 to about 100 PHR, about 75 to about 95 PHR, about 75 to about 90 PHR, about 75 to about 85 PHR, about 75 to about 80 PHR, about 80 to about 150 PHR, about 80 to about 145 PHR, about 80 to about 140 PHR, about 80 to about 135 PHR, about 80 to about 130 PHR, about 80 to about 125 PHR, about 80 to about 120 PHR, about 80 to about 115 PHR, about 80 to about 110 PHR, about 80 to about 105 PHR, about 80 to about 100 PHR, about 80 to about 95 PHR, about 80 to about 90 PHR, about 80 to about 85 PHR, about 85 to about 150 PHR, about 85 to about 145 PHR, about 85 to about 140 PHR, about 85 to about 135 PHR, about 85 to about 130 PHR, about 85 to about 125 PHR, about 85 to about 120 PHR, about 85 to about 115 PHR, about 85 to about 110 PHR, about 85 to about 105 PHR, about 85 to about 100 PHR, about 85 to about 95 PHR, about 85 to about 90 PHR, about 90 to about 150 PHR, about 90 to about 145 PHR, about 90 to about 140 PHR, about 90 to about 135 PHR, about 90 to about 130 PHR, about 90 to about 125 PHR, about 90 to about 120 PHR, about 90 to about 115 PHR, about 90 to about 110 PHR, about 90 to about 105 PHR, about 90 to about 100 PHR, about 90 to about 95 PHR, about 95 to about 150 PHR, about 95 to about 145 PHR, about 95 to about 140 PHR, about 95 to about 135 PHR, about 95 to about 130 PHR, about 95 to about 125 PHR, about 95 to about 120 PHR, about 95 to about 115 PHR, about 95 to about 110 PHR, about 95 to about 105 PHR, about 95 to about 100 PHR, about 100 to about 150 PHR, about 100 to about 145 PHR, about 100 to about 140 PHR, about 100 to about 135 PHR, about 100 to about 130 PHR, about 100 to about 125 PHR, about 100 to about 120 PHR, about 100 to about 115 PHR, about 100 to about 110 PHR, about 100 to about 105 PHR, about 105 to about 150 PHR, about 105 to about 145 PHR, about 105 to about 140 PHR, about 105 to about 135 PHR, about 105 to about 130 PHR, about 105 to about 125 PHR, about 105 to about 120 PHR, about 105 to about 115 PHR, about 105 to about 110 PHR, about 110 to about 150 PHR, about 110 to about 145 PHR, about 110 to about 140 PHR, about 110 to about 135 PHR, about 110 to about 130 PHR, about 110 to about 125 PHR, about 110 to about 120 PHR, about 110 to about 115 PHR, about 115 to about 150 PHR, about 115 to about 145 PHR, about 115 to about 140 PHR, about 115 to about 135 PHR, about 115 to about 130 PHR, about 115 to about 125 PHR, about 115 to about 120 PHR, about 120 to about 150 PHR, about 120 to about 145 PHR, about 120 to about 140 PHR, about 120 to about 135 PHR, about 120 to about 130 PHR, about 120 to about 125 PHR, about 125 to about 150 PHR, about 125 to about 145 PHR, about 125 to about 140 PHR, about 125 to about 135 PHR, about 125 to about 130 PHR, about 130 to about 150 PHR, about 130 to about 145 PHR, about 130 to about 140 PHR, about 130 to about 135 PHR, about 135 to about 150 PHR, about 135 to about 145 PHR, about 135 to about 140 PHR, about 140 to about 150 PHR, about 140 to about 145 PHR, or about 145 to about 150 PHR.

In any aspect or embodiment described herein, the one or more silica is/are present in an amount of about 55 to about 150 PHR (e.g., about 55 to about 125 PHR, about 55 to about 95 PHR, about 65 to about 85 PHR or about 75 PHR). For example, in any aspect or embodiment described herein, the one or more silica is/are present in an amount of about 55 to about 150 PHR, about 55 to about 145 PHR, about 55 to about 140 PHR, about 55 to about 135 PHR, about 55 to about 130 PHR, about 55 to about 125 PHR, about 55 to about 120 PHR, about 55 to about 115 PHR, about 55 to about 110 PHR, about 55 to about 105 PHR, about 55 to about 100 PHR, about 55 to about 95 PHR, about 55 to about 90 PHR, about 55 to about 85 PHR, about 55 to about 80 PHR, about 55 to about 75 PHR, about 55 to about 70 PHR, about 55 to about 65 PHR, about 55 to about 60 PHR, about 60 to about 150 PHR, about 60 to about 145 PHR, about 60 to about 140 PHR, about 60 to about 135 PHR, about 60 to about 130 PHR, about 60 to about 125 PHR, about 60 to about 120 PHR, about 60 to about 115 PHR, about 60 to about 110 PHR, about 60 to about 105 PHR, about 60 to about 100 PHR, about 60 to about 95 PHR, about 60 to about 90 PHR, about 60 to about 85 PHR, about 60 to about 80 PHR, about 60 to about 75 PHR, about 60 to about 70 PHR, about 60 to about 65 PHR, about 65 to about 150 PHR, about 65 to about 145 PHR, about 65 to about 140 PHR, about 65 to about 135 PHR, about 65 to about 130 PHR, about 65 to about 125 PHR, about 65 to about 120 PHR, about 65 to about 115 PHR, about 65 to about 110 PHR, about 65 to about 105 PHR, about 65 to about 100 PHR, about 65 to about 95 PHR, about 65 to about 90 PHR, about 65 to about 85 PHR, about 65 to about 80 PHR, about 65 to about 75 PHR, about 65 to about 70 PHR, about 70 to about 150 PHR, about 70 to about 145 PHR, about 70 to about 140 PHR, about 70 to about 135 PHR, about 70 to about 130 PHR, about 70 to about 125 PHR, about 70 to about 120 PHR, about 70 to about 115 PHR, about 70 to about 110 PHR, about 70 to about 105 PHR, about 70 to about 100 PHR, about 70 to about 95 PHR, about 70 to about 90 PHR, about 70 to about 85 PHR, about 70 to about 80 PHR, about 70 to about 75 PHR, about 75 to about 150 PHR, about 75 to about 145 PHR, about 75 to about 140 PHR, about 75 to about 135 PHR, about 75 to about 130 PHR, about 75 to about 125 PHR, about 75 to about 120 PHR, about 75 to about 115 PHR, about 75 to about 110 PHR, about 75 to about 105 PHR, about 75 to about 100 PHR, about 75 to about 95 PHR, about 75 to about 90 PHR, about 75 to about 85 PHR, about 75 to about 80 PHR, about 80 to about 150 PHR, about 80 to about 145 PHR, about 80 to about 140 PHR, about 80 to about 135 PHR, about 80 to about 130 PHR, about 80 to about 125 PHR, about 80 to about 120 PHR, about 80 to about 115 PHR, about 80 to about 110 PHR, about 80 to about 105 PHR, about 80 to about 100 PHR, about 80 to about 100 PHR, about 80 to about 95 PHR, about 80 to about 90 PHR, about 80 to about 85 PHR, about 85 to about 150 PHR, about 85 to about 145 PHR, about 85 to about 140 PHR, about 85 to about 135 PHR, about 85 to about 130 PHR, about 85 to about 125 PHR, about 85 to about 120 PHR, about 85 to about 115 PHR, about 85 to about 110 PHR, about 85 to about 105 PHR, about 85 to about 100 PHR, about 85 to about 95 PHR, about 85 to about 90 PHR, about 90 to about 150 PHR, about 90 to about 145 PHR, about 90 to about 140 PHR, about 90 to about 135 PHR, about 90 to about 130 PHR, about 90 to about 125 PHR, about 90 to about 120 PHR, about 90 to about 115 PHR, about 90 to about 110 PHR, about 90 to about 105 PHR, about 90 to about 100 PHR, about 90 to about 95 PHR, about 95 to about 150 PHR, about 95 to about 145 PHR, about 95 to about 140 PHR, about 95 to about 135 PHR, about 95 to about 130 PHR, about 95 to about 125 PHR, about 95 to about 120 PHR, about 95 to about 115 PHR, about 95 to about 110 PHR, about 95 to about 105 PHR, about 95 to about 100 PHR, about 100 to about 150 PHR, about 100 to about 145 PHR, about 100 to about 140 PHR, about 100 to about 135 PHR, about 100 to about 130 PHR, about 100 to about 125 PHR, about 100 to about 120 PHR, about 100 to about 115 PHR, about 100 to about 110 PHR, about 100 to about 105 PHR, about 105 to about 150 PHR, about 105 to about 145 PHR, about 105 to about 140 PHR, about 105 to about 135 PHR, about 105 to about 130 PHR, about 105 to about 125 PHR, about 105 to about 120 PHR, about 105 to about 115 PHR, about 105 to about 110 PHR, about 110 to about 150 PHR, about 110 to about 145 PHR, about 110 to about 140 PHR, about 110 to about 135 PHR, about 110 to about 130 PHR, about 110 to about 125 PHR, about 110 to about 120 PHR, about 110 to about 115 PHR, about 115 to about 150 PHR, about 115 to about 145 PHR, about 115 to about 140 PHR, about 115 to about 135 PHR, about 115 to about 130 PHR, about 115 to about 125 PHR, about 115 to about 120 PHR, about 120 to about 150 PHR, about 120 to about 145 PHR, about 120 to about 140 PHR, about 120 to about 135 PHR, about 120 to about 130 PHR, about 120 to about 125 PHR, about 125 to about 150 PHR, about 125 to about 145 PHR, about 125 to about 140 PHR, about 125 to about 135 PHR, about 125 to about 130 PHR, about 130 to about 150 PHR, about 130 to about 145 PHR, about 130 to about 140 PHR, about 130 to about 135 PHR, about 135 to about 150 PHR, about 135 to about 145 PHR, about 135 to about 140 PHR, about 140 to about 150 PHR, about 140 to about 145 PHR, about 145 to about 150 PHR.

In any aspect or embodiment described herein, the one or more carbon black is/are present in an amount of about 5.0 to about 20.0 PHR (e.g., about 7.0 to about 17.0 PHR or about 12 PHR). For example, in any aspect or embodiment described herein, the one or more carbon black is/are present in an amount of about 5 to about 20 PHR, about 5 to about 17.5 PHR, about 5 to about 15 PHR, about 5 to about 12.5 PHR, about 5 to about 10 PHR, about 5 to about 7.5 PHR, about 7.5 to about 20 PHR, about 7.5 to about 17.5 PHR, about 7.5 to about 15 PHR, about 7.5 to about 12.5 PHR, about 7.5 to about 10 PHR, about 10.0 to about 20 PHR, about 10.0 to about 17.5 PHR, about 10.0 to about 15 PHR, about 10.0 to about 12.5 PHR, about 12.5 to about 20 PHR, about 12.5 to about 17.5 PHR, about 12.5 to about 15 PHR, about 15.0 to about 20 PHR, about 15.0 to about 17.5 PHR, or about 17.5 to about 20 PHR.

### Plasticizer(s)

In any aspect or embodiment described herein, the one or more plasticizer includes a processing oil (e.g. a rubber processing oil, mineral oil, vegetable oil, vegetable oil ester, or a mixture thereof), an aromatic oil (e.g., distillate aromatic extract, treated distillate aromatic extract, or a mixture thereof), or a combination thereof.

In any aspect or embodiment described herein, the vegetable oil includes or is soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof. In any aspect or embodiment described herein, the vegetable oil ester includes or is an ester of a vegetable oil that includes or is soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof.

In any aspect or embodiment described herein, the one or more plasticizer is/are present in an amount of about 15 to about 50 PHR (e.g., about 15 to about 45 PHR or about 32 PHR). For example, in any aspect or embodiment described herein, the one or more plasticizer is/are present in an amount of about 15 to about 50 PHR, about 15 to about 45 PHR, about 15 to about 40 PHR, about 15 to about 35 PHR, about 15 to about 30 PHR, about 15 to about 25 PHR, about 15 to about 20 PHR, about 20 to about 50 PHR, about 20 to about 45 PHR, about 20 to about 40 PHR, about 20 to about 35 PHR, about 20 to about 30 PHR, about 20 to about 25 PHR, about 25 to about 50 PHR, about 25 to about 45 PHR, about 25 to about 40 PHR, about 25 to about 35 PHR, about 25 to about 30 PHR, about 30 to about 50 PHR, about 30 to about 45 PHR, about 30 to about 40 PHR, about 30 to about 35 PHR, about 35 to about 50 PHR, about 35 to about 45 PHR, about 35 to about 40 PHR, about 40 to about 50 PHR, about 40 to about 45 PHR, or about 45 to about 50 PHR.

### Coupling Agent(s)

In any aspect or embodiment described herein, the compositions of the present disclosure (e.g., rubber, rubber composition, silica compounded rubber composition, tire, a silica compounded tire, etc.) further includes one or more (e.g., 1, 2, 3, 4, 5, 6, or more) saline coupling agent. In any aspect or embodiment described herein, the one or more coupling agent includes sulfur functional organosilanes, bis(triethoxysilylpropyl) tetrasulfide, bis(triethoxysilylpropyl) disulfide, 3-thiocyanatopropyltriethoxysilane, or a mixture thereof. In any aspect or embodiment described herein, the silane coupling agent bis(3-triethoxysilylpropyl) tetrasulfide, bis(3-triethoxysilylpropyl)trisulfide, bis(3-triethoxysilylpropyl) disulfide, bis(2-triethoxysilylethyl)tetrasulfide, bis(3-trimethoxysilylpropyl) tetrasulfide, bis(2-trimethoxysilylethyl)tetrasulfide, 3-mercaptopropyltrimethoxysilane, 3-mercaptopropyltriethoxysilane, 2-mercaptoethyltrimethoxysilane, 2-mercaptoethyltriethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropylbenzothiazolyl tetrasulfide, 3-triethoxysilylpropylbenzothiazolyl tetrasulfide, 3-triethoxysilylpropylmethacrylate monosulfide, 3-trimethoxysilylpropylmethacrylate monosulfide, bis(3-diethoxymethylsilylpropyl) tetrasulfide, 3-mercaptopropyldimethoxymethylsilane, dimethoxymethylsilylpropyl-N,N-dimethylthiocarbamoyl tetrasulfide, dimethoxymethylsilylpropylbenzothiazolyl tetrasulfide, or a combination thereof.

In any aspect or embodiment described herein, the one or more coupling agent is/are present in an amount of about 4 to about 12 PHR (e.g., about 6 to about 10 PHR or about 8 PHR). For example, in any aspect or embodiment described herein, the one or more coupling agent is/are present in an amount of about 4 to about 12 PHR, about 4 to about 11 PHR, about 4 to about 10 PHR, about 4 to about 9 PHR, about 4 to about 8 PHR, about 4 to about 7 PHR, about 4 to about 6 PHR, about 5 to about 12 PHR, about 5 to about 11 PHR, about 5 to about 10 PHR, about 5 to about 9 PHR, about 5 to about 8 PHR, about 5 to about 7 PHR, about 6 to about 12 PHR, about 6 to about 11 PHR, about 6 to about 10 PHR, about 6 to about 9 PHR, about 6 to about 8 PHR, about 7 to about 12 PHR, about 7 to about 11 PHR, about 7 to about 10 PHR, about 7 to about 9 PHR, about 8 to about 12 PHR, about 8 to about 11 PHR, about 8 to about 10 PHR, about 9 to about 12 PHR, about 9 to about 11 PHR, or about 10 to about 12 PHR.

In any aspect or embodiment described herein, the organosilane or sulfur functional organosilane is present in an amount of about 4 to about 8 PHR (e.g., about 6 PHR). For example, in aspect or embodiment described herein, the organosilane or sulfur functional organosilane is present in an amount of about 4 to about 8 PHR, about 4 to about 7 PHR, about 4 to about 6 PHR, about 4 to about 5 PHR, about 5 to about 8 PHR, about 5 to about 7 PHR, about 5 to about 6 PHR, about 6 to about 8 PHR, about 6 to about 7 PHR, or about 7 to about 8 PHR.

In any aspect or embodiment described herein, the diphenyl guanidine (DPG) is present in an amount of about 0.5 to about 4 PHR (e.g., about 1 to about 3 PHR or about 2 PHR). For example, in any aspect or embodiment described herein, the diphenyl guanidine (DPG) is present in an amount of about 0.5 to about 4 PHR, about 0.5 to about 3 PHR, about 0.5 to about 2 PHR, about 0.5 to about 1 PHR, about 1 to about 4 PHR, about 1 to about 3 PHR, about 1 to about 2 PHR, about 2 to about 4 PHR, about 2 to about 3 PHR, or about 3 to about 4 PHR.

### Vulcanization Accelerator(s)

In any aspect or embodiment described herein, the compositions of the present disclosure (e.g., rubber, rubber composition, silica compounded rubber composition, tire, a silica compounded tire, etc.) includes one or more (e.g., 1, 2, 3, 4, 5, 6, or more) accelerator (e.g., a vulcanization accelerator). For example, in any aspect or embodiment described herein, each accelerator is independently an amine-based or aldehyde-amine-based accelerator (e.g., cyclohexylethylamine mexamethylene tetramine (HMT), ethyldiene aniline (EA), butyraldehyde dianiline (BA) condensation product, or a combination thereof), a guanidine-based accelerator (e.g., diphenyl guanidine (DPG), DPG di-o-tolyl guanidine (DOTG), DOTG triphenyl guanidine (TPG), or a combination thereof), a thiuram-based accelerator (e.g., tetramethyl thiuram disulfide (TMTD), tetraethyl thiuram disulfide (TETD), tetramethyl thiuram monosulfide (TMTM), dipentamethylene thiuram tetrasulfate (DPTS), dipentaethylene thiuram (DPTT), or a combination thereof), dithiocarbamate-based accelerator (e.g., zinc diethyl dithiocarbamate (ZDEC), N-dimethyl dithiocarbamate (ZDMC), zinc N-dibutyl dithiocarbamate (ZDBC), piperdiene pentamethylene dithiocarbamate (PPD), sodium diethyl dithiocarbamate (SDC), zinc ethyl phenyl dithiocarbamate), or a combination thereof), a thiazole (mercapto)-based accelerator (e.g., 2-mercaptobenzothiazole (MBT), 2,2′-dithiobenzothiazole (MBTS), sodium salt of MBT, 2,4-dinitrophenyl mercaptobezothiazole (DMB), zinc mercaptobenzothiazolc (ZMBT), 2-morpholinochiobenzothiaxole (MBS)), or a combination thereof), a sulfonamide-based accelerator (e.g., N-cyclohexyl benzothiazole-2-sulfonamide (CBS), N-1-butylbenzothiazole-2-sulfonamide (TBBS), N-dicyclohexylbenzothiazole-2-sulfenamice (DCBS), or a combination thereof), a thiourea-based accelerator (e.g., ethylenethiourea (ETU), diethlyenethiourca (DETU), diphenylthiourea (DPTU)), or a combination thereof), a dithiophosphate-based accelerator (e.g., zinc dithiophosphate), a xanthate-based accelerator (e.g., zinc isopropyl xanthate (ZIX), sodium isopropyl xanthate (SIX), zinc butyl xanthate (ZBX), or a combination thereof), or a combination thereof.

In any aspect or embodiment described herein, the one or more vulcanization accelerator includes stearic acid, zinc oxide, or a combination thereof.

In any aspect or embodiment described herein, the one or more vulcanizing accelerator is/are present in amount of about 2 to about 8.5 PHR (e.g., about 5.2 PHR). For example, in any aspect or embodiment described herein, the one or more vulcanizing accelerator is/are present in amount of about 2 to about 8.5 PHR, about 2 to about 8 PHR, about 2 to about 7 PHR, about 2 to about 6 PHR, about 2 to about 5 PHR, about 2 to about 4 PHR, about 2 to about 3 PHR, about 3 to about 8.5 PHR, about 3 to about 8 PHR, about 3 to about 7 PHR, about 3 to about 6 PHR, about 3 to about 5 PHR, about 3 to about 4 PHR, about 4 to about 8.5 PHR, about 4 to about 8 PHR, about 4 to about 7 PHR, about 4 to about 6 PHR, about 4 to about 5 PHR, about 5 to about 8.5 PHR, about 5 to about 8 PHR, about 5 to about 7 PHR, about 5 to about 6 PHR, about 6 to about 8.5 PHR, about 6 to about 8 PHR, about 6 to about 7 PHR, about 7 to about 8.5 PHR, about 7 to about 8 PHR, or about 8 to about 8.5 PHR.

In any aspect or embodiment described herein, the sulfenamide-based accelerator (e.g., N-tert-butyl-benzothiazole sulfonamide (TBBS)) is present in an amount of about 0.5 to about 3 PHR (e.g., about 1 to about 2.5 PHR or about 1.7 PHR). For example, in any aspect or embodiment described herein, the sulfenamide-based accelerator (e.g., N-tert-butyl-benzothiazole sulfonamide (TBBS)) is present in an amount of about 0.5 to about 3 PHR, about 0.5 to about 2.5 PHR, about 0.5 to about 2.0 PHR, about 0.5 to about 1.5 PHR, about 0.5 to about 1.0 PHR, about 1.0 to about 3 PHR, about 1.0 to about 2.5 PHR, about 1.0 to about 2.0 PHR, about 1.0 to about 1.5 PHR, about 1.5 to about 3 PHR, about 1.5 to about 2.5 PHR, about 1.5 to about 2.0 PHR, about 2.0 to about 3 PHR, about 2.0 to about 2.5 PHR, or about 2.5 to about 3.0 PHR.

In any aspect or embodiment described herein, the zinc oxide is present in an amount of about 1 to about 4 PHR (e.g., about 1.5 to about 3.5 PHR or 2.5 PHR). For example, in any aspect or embodiment described herein, the zinc oxide is present in an amount of about 1.0 to about 4.0 PHR, about 1.0 to about 3.5 PHR, about 1.0 to about 3.0 PHR, about 1.0 to about 2.5 PHR, about 1.0 to about 2.0 PHR, about 1.0 to about 1.5 PHR, about 1.5 to about 4.0 PHR, about 1.5 to about 3.5 PHR, about 1.5 to about 3.0 PHR, about 1.5 to about 2.5 PHR, about 1.5 to about 2.0 PHR, about 2.0 to about 4.0 PHR, about 2.0 to about 3.5 PHR, about 2.0 to about 3.0 PHR, about 2.0 to about 2.5 PHR, about 2.5 to about 4.0 PHR, about 2.5 to about 3.5 PHR, about 2.5 to about 3.0 PHR, about 3.0 to about 4.0 PHR, about 3.0 to about 3.5 PHR, or about 3.5 to about 4.0 PHR.

In any aspect or embodiment described herein, the stearic acid is present in an amount of about 0.5 to about 1.5 PHR (e.g., about 0.75 to about 1.25 PHR or about 1 PHR). For example, in any aspect or embodiment described herein, the stearic acid is present in an amount of about 0.5 to about 1.5 PHR, about 0.5 to about 1.25 PHR, about 0.5 to about 1.0 PHR, about 0.5 to about 0.75 PHR, about 0.75 to about 1.5 PHR, about 0.75 to about 1.25 PHR, about 0.75 to about 1.0 PHR, about 1.0 to about 1.5 PHR, about 1.0 to about 1.25 PHR, or about 1.25 to about 1.5 PHR.

### Antiaging Agent(s)

In any aspect or embodiment described herein, the one or more antiaging agent includes one or more (e.g., 1, 2, 3, 4, 5, 6, or more) antioxidant (e.g., N1-(4-methylpentan-2-yl)-N4-phenylbenzene-1,4-diamine (6PPD), polymerized 2,2,4-Trimethyl-1,1-dihydroquinoline (TMQ), or a mixture thereof).

In any aspect or embodiment described herein, the one or more antiaging agent includes one or more (e.g., 1, 2, 3, 4, 5, 6, or more) antiozonant (e.g., a wax, paraffin wax, refined paraffin wax, refined paraffin was derived from petroleum, a fully refined paraffin wax derived from petroleum, or a mixture thereof).

In any aspect or embodiment described herein, the one or more antiaging agent is/are present in an amount of about 3 to about 8 PHR (e.g., about 4 to about 7 PHR or about 5.5 PHR). For example, in any aspect or embodiment described herein, the one or more antiaging agent is/are present in an amount of about 3 to about 8 PHR, about 3 to about 7 PHR, about 3 to about 6 PHR, about 3 to about 5 PHR, about 3 to about 4 PHR, about 4 to about 8 PHR, about 4 to about 7 PHR, about 4 to about 6 PHR, about 4 to about 5 PHR, about 5 to about 8 PHR, about 5 to about 7 PHR, about 5 to about 6 PHR, about 6 to about 8 PHR, about 6 to about 7 PHR, or about 7 to about 8 PHR.

In any aspect or embodiment described herein, the one or more antioxidant is/are present in an amount of about 2 to about 6 PHR (e.g., about 3 to about 5 PHR or 4 PHR). For example, in any aspect or embodiment described herein, the one or more antioxidant is/are present in an amount of about 2 to about 6 PHR, about 2 to about 5 PHR, about 2 to about 4 PHR, about 2 to about 3 PHR, about 3 to about 6 PHR, about 3 to about 5 PHR, about 3 to about 4 PHR, about 4 to about 6 PHR, about 4 to about 5 PHR, or about 5 to about 6 PHR.

In any aspect or embodiment described herein, the one or more antiozonant is/are present in an amount of about 1 to about 2 PHR (e.g., about 1.25 to about 1.75 PHR or 1.5 PHR). For example, in any aspect or embodiment described herein, the one or more antiozonant is/are present in an amount of about 1.0 to about 2.0 PHR, about 1.0 to about 1.75 PHR, about 1.0 to about 1.5 PHR, about 1.0 to about 1.25 PHR, about 1.25 to about 2 PHR, about 1.25 to about 1.75 PHR, about 1.25 to about 1.5 PHR, about 1.5 to about 2.0 PHR, about 1.5 to about 1.75 PHR, or about 1.75 to about 2.0 PHR.

### Cross-linking or Vulcanization Agent(s)

In any aspect or embodiment described herein, the one or more cross-linking or vulcanization agent includes, consists essentially of, or consists of sulfur.

In any aspect or embodiment described herein, the one or more cross-linking or vulcanization agent is/are present in an amount of about 0.4 to about 2.4 PHR (e.g., about 0.9 to about 1.9 PHR or about 1.4 PHR). For example, in any aspect or embodiment described herein, the one or more cross-linking or vulcanization agent is/are present in an amount of about 0.4 to about 2.4 PHR, about 0.4 to about 2.0 PHR, about 0.4 to about 1.75 PHR, about 0.4 to about 1.5 PHR, about 0.4 to about 1.25 PHR, about 0.4 to about 1.0 PHR, about 0.5 to about 2.4 PHR, about 0.5 to about 2.0 PHR, about 0.5 to about 1.75 PHR, about 0.5 to about 1.5 PHR, about 0.5 to about 1.25 PHR, about 0.5 to about 1.0 PHR, about 0.5 to about 0.75 PHR, about 0.75 to about 2.4 PHR, about 0.75 to about 2.0 PHR, about 0.75 to about 1.75 PHR, about 0.75 to about 1.5 PHR, about 0.75 to about 1.25 PHR, about 0.75 to about 1.0 PHR, about 1.0 to about 2.4 PHR, about 1.0 to about 2.0 PHR, about 1.0 to about 1.75 PHR, about 1.0 to about 1.5 PHR, about 1.0 to about 1.25 PHR, about 1.25 to about 2.4 PHR, about 1.25 to about 2.0 PHR, about 1.25 to about 1.75 PHR, about 1.25 to about 1.5 PHR, about 1.5 to about 2.4 PHR, about 1.5 to about 2.0 PHR, about 1.5 to about 1.75 PHR, about 1.75 to about 2.4 PHR, about 1.75 to about 2.0 PHR, or about 2.0 to about 2.4 PHR.

### Method of Making Rubber

An aspect or the present disclosure provides a method of making the rubber composition of the present disclosure, the method comprising, consisting essentially of, or consisting of, contacting one or more (e.g., 1, 2, 3, 4, 5, 6, or more) filler that includes one or more (e.g., 1, 2, 3, 4, 5, 6, or more) silica, one or more (e.g., 1, 2, 3, 4, 5, 6, or more) elastomer (e.g. one or more functionalized elastomer), and the additive composition (e.g., an additive composition for silica compounded rubber composition) of the present disclosure.

In any aspect or embodiment described herein, contacting the one or more silica, the one or more rubber, and the additive composition comprises, consisting essentially of, or consisting of: (a) preparing a first mixture comprising, consisting essentially of, or consisting of, combining and/or mixing the one or more elastomer (e.g., a butadiene-based rubber, styrene butadiene copolymer rubber, polybutadiene, or a combination thereof), the one or more silica (e.g., silicon dioxide), the one or more coupling agent (e.g., bis(triethoxysilylpropyl) tetrasulfide), the one or more plasticizer (e.g., distillate aromatic extract, treated distillate aromatic extract, or a mixture thereof), or a combination thereof.

In any aspect or embodiment described herein, preparing the first mixture includes, consists essentially of, or consists of: adding the one or more plasticizer to the mixture the one or more elastomer, the one or more silica, and/or the one or more coupling agent, at a temperature of about 75° C. to about 95° C. (e.g., about 75° C. to about 90° C., about 75° C. to about 85° C., about 80° C. to about 95° C., about 80° C. to about 90° C., about 85° C. to about 95° C., or about 82° C.); mixing/sweeping the first mixture at a temperature of about 100° C. to about 115° C. (e.g., about 100° C. to about 110° C., about 100° C. to about 105° C., about 105° C. to about 115° C., about 105° C. to about 110° C., about 110° C. to about 115° C., or about 110° C.); mixing/sweeping the mixture at a temperature of about 115° C. to about 135° C. (e.g., about 115° C. to about 130° C., about 115° C. to about 125° C., about 115° C. to about 120° C., about 120° C. to about 135° C., about 120° C. to about 130° C., about 120° C. to about 125° C., about 125° C. to about 135° C., about 125° C. to about 130° C., about 130° C. to about 135° C., or about 127° C.); holding the first mixture at a temperature of about 145° C. to about 160° C. (e.g., holding the first mixture for about 2 to 8 minutes or about 2 to about 5 minutes, and/or at about 145° C. to about 160° C., about 145° C. to about 155° C., about 145° C. to about 150° C., about 150° C. to about 160° C., about 150° C. to about 155° C., or about 155° C. to about 160° C.); or a combination thereof.

In any aspect or embodiment described herein, contacting the one or more silica, the one or more rubber, and the additive composition comprises, consisting essentially of, or consisting of: preparing a second mixture comprising, consisting essentially of, or consisting of, combining and/or mixing the first mixture, at least one (e.g., 1, 2, 3, 4, 5, or more) of the one or more filler (e.g., carbon black, such as N330 carbon black), at least one (e.g., 1, 2, 3, 4, 5, or more) of the one or more plasticizer (e.g., distillate aromatic extract, treated distillate aromatic extract, or a mixture thereof), the one or more antiaging agent (e.g., polymerized 2,2,4-Trimethyl-1,1-dihydroquinoline (TMQ), N1-(4-methylpentan-2-yl)-N4-phenylbenzene-1,4-diamine (6PPD), paraffin wax, or a combination thereof), the one or more vulcanizing accelerator (e.g., zinc oxide, stearic acid, or a combination thereof), the additive composition, or a combination thereof.

In any aspect or embodiment described herein, preparing the second mixture includes, consists essentially of, or consists of: combining the first mixture, the at least one of the one or more filler, and the at least one of the one or more plasticizer; combining at a temperature of about 75° C. to about 90° C. (e.g., about 75° C. to about 85° C., about 75° C. to about 80° C., about 80° C. to about 90° C., about 80° C. to about 85° C., about 85° C. to about 90° C., or about 82° C.); mixing/sweeping the second mixture at a temperature of about 100° C. to about 115° C. (e.g., about 100° C. to about 115° C., about 100° C. to about 110° C., about 100° C. to about 105° C., about 105° C. to about 115° C., about 105° C. to about 110° C., about 110° C. to about 115° C., or about 110° C.); holding the third mixture at a temperature of about 130° C. to about 145° C. (e.g., holding the second mixture for about 2 to 8 minutes or about 2 to about 5 minutes, and/or at about 130° C. to about 145° C., about 130° C. to about 140° C., about 130° C. to about 135° C., about 135° C. to about 145° C., about 135° C. to about 140° C., about 140° C. to about 145° C., or about 138° C.); or a combination thereof.

In any aspect or embodiment described herein, contacting the one or more silica, the one or more rubber, and the additive composition comprises, consisting essentially of, or consisting of: preparing a third mixture comprising, consisting essentially of, or consisting of, combining and/or mixing the second mixture, at least one (e.g., 1, 2, 3, 4, 5, or more) of the one or more of the vulcanizing accelerator (e.g., N-tert-butyl-benzothiazole sulfonamide (TBBS)), at least one (e.g., 1, 2, 3, 4, 5, or more) of the one or more coupling agent (e.g., diphenyl guanidine (DPG)), at least one of the one or more cross-linking or vulcanizing agent (e.g., sulfur), or a combination thereof.

In any aspect or embodiment described herein, preparing the third mixture includes, consists essentially of, or consists of: combining (e.g., sandwiching in) the second mixture, the at least one of one or more vulcanizing accelerator, the at least one of the one or more coupling agent, the one or more cross-linking or vulcanizing agent, or a combination thereof; mixing/sweeping the third composition at a temperature of about 75° C. to about 110° C. (e.g., about 75° C. to about 105° C., about 75° C. to about 100° C., about 75° C. to about 95° C., about 75° C. to about 90° C., about 75° C. to about 85° C., about 80° C. to about 110° C., about 80° C. to about 105° C., about 80° C. to about 100° C., about 80° C. to about 95° C., about 80° C. to about 90° C., about 85° C. to about 110° C., about 85° C. to about 105° C., about 85° C. to about 100° C., about 85° C. to about 95° C., about 90° C. to about 110° C., about 90° C. to about 105° C., about 90° C. to about 100° C., about 95° C. to about 110° C., about 95° C. to about 105° C., or about 100° C. to about 110° C.); or a combination thereof.

### Tires

Another aspect of the present disclosure provides a tire (e.g., a silica compounded tire) comprising, consisting essentially of, or consisting of, the additive composition (e.g., an additive composition for silica compounded rubber composition) of the present disclosure, the rubber composition of the present disclosure, or a rubber composition prepared according to the method of the present disclosure.

In any aspect or embodiment described herein, the tire further comprises, consists essentially of, or consists of, a framework or structural reinforcements.

In any aspect or embodiment described herein, the framework or structure reinforcements include a metal (e.g., steel fibers/cords, brass coated steel fibers/cords, or a combination thereof), a textile/fabric (e.g., synthetic textile/fabric (such as, polyester textile/fabric, nylon textile/fabric, rayon textile/fabric, aramid textile/fabric, or a combination thereof), a natural textile/fabric (such as, cotton textile/fabric, silk textile/fabric, or a combination thereof), or a combination thereof), or a combination thereof.

### EXAMPLES

### Example 1: Making the Additive

Six (6) compounds were selected to analyze the effects of the synthesized functional group (amidoamine, imidazoline, bisamide), as well as the effects of the amine length, on performance. Diethylenetriamine (DETA) was specifically chosen as the primary target as it was believed the small amine chain would interact with the surface morphology of silica particles more significantly. The smaller size of the amine chain should allow for greater penetration into the pore of the silica surface. Longer amine chains and chains that are terminated tertiary amines were examined to further support the claimed invention. The six (6) examined are as follows: (Inventive Ex. 1) diethylenetriamine (DETA) oleic acid amidoamine, (Inventive Ex. 2) diethylenetriamine (DETA) oleic acid imidazoline, (Inventive Ex. 3) diethylenetriamine (DETA) oleic acid bisamide, (Inventive Ex. 4)triethylenetetramine (TETA) oleic acid amidoamine, (Inventive Ex. 5) tetraethylenepentamine (TEPA) oleic acid amidoamine, and (Inventive Ex. 6) dimethylaminopropylamine (DMAPA) oleic acid amidoamine. The synthetic schemes for the synthesis of fatty acid amine adducts are as follows:

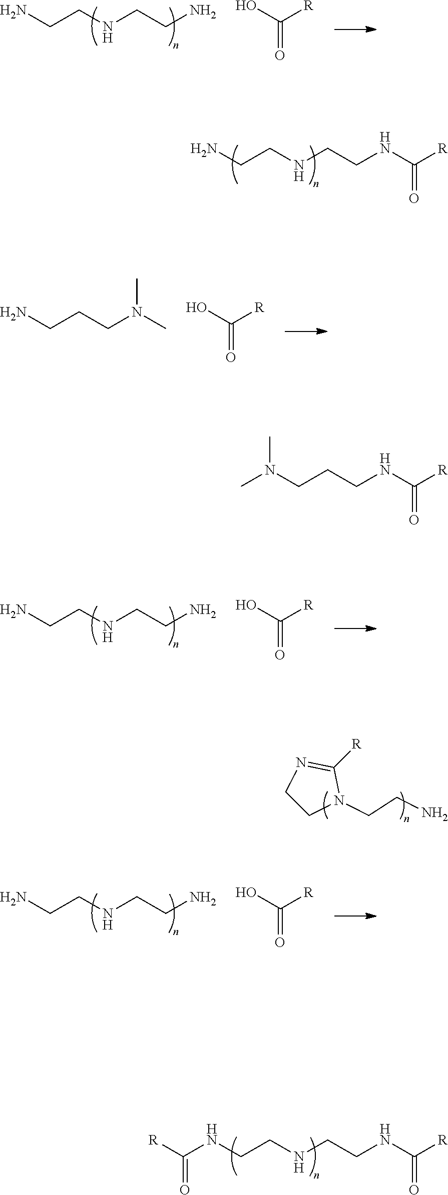

General Amidoamine and Bisamide Methodology: Oleic acid (1 eq.) and polyalkylenepolyamine (1-2 eq.) were charged to a round bottom flask. The amine charge results in an exotherm. The flask was fitted with a stirrer and placed under a nitrogen blanket. The mixture was heated to 160° C., checking the acid number at regular intervals. Once the acid number was below about 10.0 a sample was pulled to measure for imidazoline content by IR. The reaction temperature was dropped from 160 C to 120° C. and water removed. The samples were dried for approximately 1 hour in this manner. For synthesis making use of dimethylaminopropyl amine, reaction temperature was steadily raised to 220° C.

Imidazoline Methodology: Oleic acid (1 eq.) was charged to a round bottom flask fitted with stirrer, condenser, and dean-Stark trap. The acid was heated to 160° C. under nitrogen. Once at temperature, DETA (1 eq.) was added over approximately 2 hours. The temperature was then raised to 260° C. The acid value and imidazoline content were measured at regular intervals. At 260° C. a sparge of nitrogen was begun to further remove water. Once a suitable property value was reached the sample was cooled and transferred.

The physical properties and identities are shown below in Table 8 along with their physical states, which vary from liquids to waxes. Additional characteristics of the exemplary additives and controls are shown below in Table 9. All of the compounds mixed similarly and consumed similar amounts of energy. The Control and Control 2 are the presented formula without an additive included. Control was prepared with, and thus compared with, Inventive Ex. 1-6, and Control 2 was prepared with, and thus compared with, Inventive Ex. 1 Adj. Blend 1 is the presented formula with a blend of rosin ester tackifier and fatty acid ester used as a control additive. For Control 2 and Inventive Ex. 1-Adj, the first pass and second pass were mixed in the mixer, but the final pass was mixed on the mill. Inventive Ex. 1-Adj was split into three (3) to allow for three (3) different cure adjustments to try to increase the Ts2 (the abrasion time for the viscosity to increase 2 units above minimum torque (ML)), slightly reduce T_{c90} (the time it takes to get to 90% of the maximum state of cure/cross-linking (MH or maximum torque)), and increase the maximum torque (MH) to more closely match the Moving Die Rheometer (MDR) curve of the control compound. The first adjustment ended up being the closest adjustment and that version was used for the rest of the testing for Inventive Ex. 1-Adj.

TABLE 8
Characteristics of exemplary additives of the present disclosure

| Sample | Acid | Amine | | | Pour | Water | Flash |
|---|---|---|---|---|---|---|---|
| Name | Number | Value | Imidazoline | Amidoamine | Point | Solubility | Point |
| Inventive | 10.9 | 321.00 | 0 | 100 | 36 | Very | >200 C. |
| Ex. 1 | | | | | | limited | |
| Inventive | 6.9 | 104.79 | 0 | 100 | 78 | none | >200 C. |
| Ex. 3 | | | | | | | |
| Inventive | 0.7 | 298.48 | 80 | 20 | −27 | Partial ~2% | >200 C. |
| Ex. 2 | | | | | | | |
| Inventive | 4.1 | 392.63 | 0 | 100 | −12 | Very | >200 C. |
| Ex. 5 | | | | | | Limited | |
| Inventive | 7.4 | 322.93 | 0 | 100 | 45 | Very | >200 C. |
| Ex. 4 | | | | | | Limited | |
| Inventive | 8.9 | 163.47 | 0 | 100 | 0 | Partial ~1% | 113 |
| Ex. 6 | | | | | | | |

TABLE 9
Characteristics of Exemplary Additives of the Present Disclosure and Controls

| | | | Inventive | Inventive | Inventive | Inventive | Inventive | Inventive | Control | Inventive |
|---|---|---|---|---|---|---|---|---|---|---|
| | Control | Blend 1 | Ex. 2 | Ex. 1 | Ex. 3 | Ex. 4 | Ex.5 | Ex. 6 | 2 | Ex. 1 Adj |
| Mix Time | 10.05 | 10.52 | 10.07 | 9.08 | 9.88 | 9.57 | 9.12 | 9.88 | 12.80 | 11.57 |
| (minutes) | | | | | | | | | | |
| Probe | 319 | 303 | 311 | 317 | 314 | 317 | 317 | 316 | 302 | 308 |
| Temp (° F.) | | | | | | | | | | |
| Total Power | 3.96 | 4.14 | 3.94 | 3.68 | 3.81 | 3.83 | 3.59 | 3.78 | 5.20 | 4.62 |
| (kW*hr) | | | | | | | | | | |
| Mix Time | 8.90 | 10.22 | 9.18 | 8.37 | 9.87 | 9.33 | 8.92 | 9.97 | 11.85 | 10.82 |
| (minutes) | | | | | | | | | | |
| Probe | 294 | 295 | 305 | 294 | 301 | 299 | 297 | 297 | 305 | 302 |
| Temp (° F.) | | | | | | | | | | |
| Total Power | 2.55 | 2.69 | 2.55 | 2.41 | 2.71 | 2.67 | 2.55 | 2.66 | 3.39 | 3.08 |
| (kW*br) | | | | | | | | | | |
| Mix Time | 3.57 | 4.13 | 3.45 | 3.73 | 4.13 | 2.92 | 3.48 | 4.65 | Cure | Cure |
| (minutes) | | | | | | | | | added on | added on |
| Temp (° F.) | 250 | 246 | 246 | 248 | 246 | 244 | 245 | 248 | mill | mill |
| Total Power | 1.13 | 1.26 | 1.02 | 1.12 | 1.23 | 0.89 | 1.07 | 1.37 | | |
| (kW*hr) | | | | | | | | | | |

### Example 2: Making the Master Batches

First Pass Master Batches. The components and amounts of the first pass master batch formulations can be found below in Table 10. Polymers, Silica, and Si-69 were combined and mixed. At 180° F., oil was added and the composition swept. This first pass master batches were swept again at 230° F. and 260° F. The first pass master batches were then held for 3 minutes at 305-310° F.

Second Pass Master Batches. The components and amounts of the second pass master batch formulations can be found below in Table 11. Carbon black and half of the oil was added to the First Master Batch. The remaining oil and materials were added at 180° F. The composition was swept at 230° F. The second pass mater batches were then held for 3 minutes at 280° F.

Final Pass Master Batches. The components and amounts of the final (third) pass master batch formulations can be found below in Table 12. The materials were sandwiches in and the composition swept at 180° F. and 220° F.

TABLE 10
Formulations of the First Pass Master Batches

| | | | Inventive | Inventive | Inventive | Inventive | Inventive | Inventive | Control | Inventive |
|---|---|---|---|---|---|---|---|---|---|---|
| | Control | Blend 1 | Ex. 2 | Ex. 1 | Ex. 3 | Ex. 4 | Ex. 5 | Ex. 6 | 2 | Ex. 1 Adj |
| | (PHR) | (PHR) | (PHR) | (PHR) | (PHR) | (PHR) | (PHR) | (PHR) | (PHR) | (PHR) |
| Functional Solution | 75.0 | 75.0 | 75.0 | 75.0 | 75.0 | 75.0 | 75.0 | 75.0 | 75.0 | 75.0 |
| Styrene Butadiene | | | | | | | | | | |
| Rubber (S-SBR) | | | | | | | | | | |
| (Trinseo SLR4602; | | | | | | | | | | |
| Berwyn, | | | | | | | | | | |
| Pennsylvania) | | | | | | | | | | |
| BUDENE ^{®} 1207 | 25.0 | 25.0 | 25.0 | 25.0 | 25.0 | 25.0 | 25.0 | 25.0 | 25.0 | 25.0 |
| (high cis-1,4 | | | | | | | | | | |
| polybutadiene | | | | | | | | | | |
| stabilized with a | | | | | | | | | | |
| non-staining | | | | | | | | | | |
| antioxidant) | | | | | | | | | | |
| (GOODYEAR ^{®} | | | | | | | | | | |
| Chemical; Akron, | | | | | | | | | | |
| Ohio) | | | | | | | | | | |
| ZEOSIL ^{®} 1165 | 75.0 | 75.0 | 75.0 | 75.0 | 75.0 | 75.0 | 75.0 | 75.0 | 75.0 | 75.0 |
| (Solvay; Princeton, | | | | | | | | | | |
| New Jersey) | | | | | | | | | | |
| Si-69 ^{®} (EVONIK; | 6.0 | 6.0 | 6.0 | 6.0 | 6.0 | 6.0 | 6.0 | 6.0 | 6.0 | 6.0 |
| Essen, Germany) | | | | | | | | | | |
| Treated Distillate | 20.0 | 20.0 | 20.0 | 20.0 | 20.0 | 20.0 | 20.0 | 20.0 | 20.0 | 20.0 |
| Aromatic Extract | | | | | | | | | | |
| (TDAE) Oil - | | | | | | | | | | |
| VIVATEC 500 | | | | | | | | | | |
| (ChemSpec, | | | | | | | | | | |
| Uniontown, Ohio) | | | | | | | | | | |
| TOTAL: | 201.0 | 201.0 | 201.0 | 201.0 | 201.0 | 201.0 | 201.0 | 201.0 | 201.0 | 201.0 |

TABLE 11
Formulations of the Second Pass Master Batches

| | | | Inventive | Inventive | Inventive | Inventive | Inventive | Inventive | Control | Inventive |
|---|---|---|---|---|---|---|---|---|---|---|
| | Control | Blend 1 | Ex. 2 | Ex. 1 | Ex. 3 | Ex. 4 | Ex. 5 | Ex. 6 | 2 | Ex. 1 Ad |
| | (PHR) | (PHR) | (PHR) | (PHR) | (PHR) | (PHR) | (PHR) | (PHR) | (PHR) | (PHR) |
| First Pass Master | 201.0 | 201.0 | 201.0 | 201.0 | 201.0 | 201.0 | 201.0 | 201.0 | 201.0 | 201.0 |
| Batch | | | | | | | | | | |
| N330 Carbon Black | 12.0 | 12.0 | 12.0 | 12.0 | 12.0 | 12.0 | 12.0 | 12.0 | 12.0 | 12.0 |
| (Orion, Spring, | | | | | | | | | | |
| Texas) | | | | | | | | | | |
| Treated Distillate | 12.0 | 12.0 | 12.0 | 12.0 | 12.0 | 12.0 | 12.0 | 12.0 | 12.0 | 12.0 |
| Aromatic Extract | | | | | | | | | | |
| (TDAE) - | | | | | | | | | | |
| VIVATEC 500 | | | | | | | | | | |
| (ChemSpec, | | | | | | | | | | |
| Uniontown, Ohio) | | | | | | | | | | |
| Polymerized 2,2,4- | 2.0 | 2.0 | 2.0 | 2.0 | 2.0 | 2.0 | 2.0 | 2.0 | 2.0 | 2.0 |
| Trimethyl-1,1- | | | | | | | | | | |
| dihydroquinoline | | | | | | | | | | |
| (TMQ) (Safic-Alcan | | | | | | | | | | |
| Ltd., Uniontown, | | | | | | | | | | |
| Ohio) | | | | | | | | | | |
| N1-(4- | 2.0 | 2.0 | 2.0 | 2.0 | 2.0 | 2.0 | 2.0 | 2.0 | 2.0 | 2.0 |
| Methylpentan-2-yl)- | | | | | | | | | | |
| N4-phenylbenzene- | | | | | | | | | | |
| 1,4-diamine (6PPD) | | | | | | | | | | |
| Paraffin Wax - | 1.5 | 1.5 | 1.5 | 1.5 | 1.5 | 1.5 | 1.5 | 1.5 | 1.5 | 1.5 |
| Akrochem 5073 | | | | | | | | | | |
| (Akron, Ohio) | | | | | | | | | | |
| Zinc Oxide | 2.5 | 2.5 | 2.5 | 2.5 | 2.5 | 2.5 | 2.5 | 2.5 | 2.5 | 2.5 |
| Stearic Acid | 1.0 | 1.0 | 1.0 | 1.0 | 1.0 | 1.0 | 1.0 | 1.0 | 1.0 | 1.0 |
| Blend 1 | | 3.0 | | | | | | | | |
| Inventive Ex. 2 | | | 3.0 | | | | | | | |
| Inventive Ex. 1 | | | | 3.0 | | | | | | 3.0 |
| Inventive Ex. 3 | | | | | 3.0 | | | | | |
| Inventive Ex. 4 | | | | | | 3.0 | | | | |
| Inventive Ex. 5 | | | | | | | 3.0 | | | |
| Inventive Ex. 6 | | | | | | | | 3.0 | | |
| TOTAL: | 234.0 | 237.0 | 237.0 | 237.0 | 237.0 | 237.0 | 237.0 | 237.0 | 234.0 | 237.0 |

TABLE 12
Formulations of the Final Pass Master Batches

| | | | | | | | | | | Inven- | Inven- | Inven- |
|---|---|---|---|---|---|---|---|---|---|---|---|---|
| | | | Inven- | Inven- | Inven- | Inven- | Inven- | Inven- | | tive | tive | tive |
| | | | tive | tive | tive | tive | tive | tive | Control | Ex. 1 | Ex. 1 | Ex. 1 |
| | Control | Blend 1 | Ex. 2 | Ex. 1 | Ex. 3 | Ex. 4 | Ex. 5 | Ex. 0 | 2 | Adj 1 | Adj 2 | Adj 3 |
| | (PHR) | (PHR) | (PHR) | (PHR) | (PHR) | (PHR) | (PHR) | (PHR) | (PHR) | (PHR) | (PHR) | (PHR) |
| 2nd Pass | 234.0 | 237.0 | 237.0 | 237.0 | 237.0 | 237.0 | 237.0 | 237.0 | 234.0 | 237.0 | 237.0 | 237.0 |
| Master Batch | | | | | | | | | | | | |
| Sulfur | 1.4 | 1.4 | 3.4 | 1.4 | 1.4 | 1.4 | 1.4 | 1.4 | 1.4 | 1.4 | 2.0 | 1.65 |
| (Akrochem, | | | | | | | | | | | | |
| Akron, Ohio) | | | | | | | | | | | | |
| N-tert-butyl- | 1.7 | 1.7 | 1.7 | 1.7 | 1.7 | 1.7 | 1.7 | 1.7 | 1.7 | 2.3 | 2.5 | 2.5 |
| benzothiazole | | | | | | | | | | | | |
| sulfonamide | | | | | | | | | | | | |
| (TBBS) | | | | | | | | | | | | |
| (Akrochem, | | | | | | | | | | | | |
| Akron, Ohio) | | | | | | | | | | | | |
| Diphenyl | 2.0 | 2.0 | 2.0 | 2.0 | 2.0 | 2.0 | 2.0 | 2.0 | 2.0 | 1.0 | 1.0 | 1.0 |
| guanidine | | | | | | | | | | | | |
| (DPG) | | | | | | | | | | | | |
| (Akrochem, | | | | | | | | | | | | |
| Akron, Ohio) | | | | | | | | | | | | |
| TOTAL: | 239.1 | 242.1 | 242.1 | 242.1 | 242.1 | 242.1 | 242.1 | 242.1 | 239.1 | 241.9 | 242.5 | 242.2 |

Characterization of First Pass Batches, Second Pass Batches, and Third Pass Batches. The temperature, amperage (amps), and integrated power of the First Pass Batches, Second Pass Batches, and Third Pass Batches while being prepared are summarized in Table 9.

Mooney Viscosity and Scorch. Mooney Viscosity is a measurement of how a polymer or rubber compound flows at processing temperatures, typically about 100° C. to about 121° C. Mooney Viscosity and Scorch were examined via American Society for Testing and Materials (ASTM) D1646 (Standard Test Methods for Rubber-Viscosity, Stress Relaxation, and Pre-Vulcanization Characteristics (Mooney Viscometer)). Briefly, the chamber/cavity, and the rotor located therein, of the Mooney machine was heated to the testing temperature, as discussed below with regards to viscosity and scorch. The sample was put into the cavity and warmed for 1 minute before the test began. Torque is measured as the rotor spins, wherein the torque equates to the test material's resistance to flow. That is, the lower the torque, the lower the viscosity and the easier it is for the test material to flow into a mold or through an extruder.

Mooney viscosity is a measure of how well a material flows at typical rubber processing temperatures. The Mooney Viscosity of the tested materials is shown below in Table 8. The Mooney Viscosities (ML (1+4) at 100° C.) all fall within the range of commonly accepted batch to batch variation (typically, +/−10 Mooney Unit (MU) for production quality control specifications).

Mooney scorch or burn time (Ts5) is the time for the viscosity (torque) to increased 5 units above minimum torque (ML) and thus, used to determine how quickly a material will begin to cure at processing temperatures (for example, in the barrel of an extruder, on a mill or calendar, etc.). The Mooney scorch of the tested materials is shown below in Table 13. All the exemplary additives and control materials reduced the Mooney scorch (30 minutes-Large Rotor at 121° C.) except for the Blend 1 and the batch with diethylenetriamine (DETA) oleic acid amidoamine and the cure adjusted. Diethylenetriamine (DETA) oleic acid imidazoline and tetraethylenepentamine (TEPA) oleic acid amidoamine had the shortest scorch times. The rest of the compounds had scorch times over 10 minutes which is preferred for most processes.

TABLE 13
Mooney Viscosity (MU) and Mooney Scorch (Ts5) of Rubbers Prepared with the Specified Additives

| | | | | | | | | | | Inventive | Inventive | Inventive |
|---|---|---|---|---|---|---|---|---|---|---|---|---|
| | | Blend | Inventive | Inventive | Inventive | Inventive | Inventive | Inventive | Control | Ex. 1 | Ex. 1 | Ex. 1 |
| | Control | 1 | Ex. 2 | Ex. 1 | Ex. 3 | Ex. 4 | Ex. 5 | Ex. 6 | 2 | Adj A | AdjB | Adj C |
| ML 1 + 4 | 74.08 | 66.99 | 73.82 | 69.19 | 64.51 | 73.53 | 76.26 | 66.79 | — | — | — | — |
| (MU)(MB) | | | | | | | | | | | | |
| ML 1 + 4 | 63.96 | 59.47 | 59.55 | 57.7 | 56.52 | 61.69 | 61.99 | 57.74 | 64.37 | 56.7 | — | — |
| (MU)(Final) | | | | | | | | | | | | |
| Mooney | 25.08 | 26.68 | 5.86 | 12.52 | 12.66 | 10.32 | 7.53 | 13.51 | 28.19 | 25.35 | 25.16 | 26.65 |
| Scorch Ts5 | | | | | | | | | | | | |
| (min) | | | | | | | | | | | | |

Cure Kinetics of Exemplary Rubbers of the Present Disclosure and Control Rubbers. The Moving Die Rheometer (MDR) is used to measure the cure kinetics of a rubber compound. The ML correlates to the viscosity of the material. The MH correlates to the maximum state of cure (modulus, tensile, etc.). The Ts1 (the abrasion time for the viscosity to increase 1 units above minimum torque (ML)) or Ts2 (the abrasion time for the viscosity to increase 2 units above minimum torque (ML)) are similar to Mooney Scorch, but at a higher temperature (curing temperature). The Tc90 is typically used to determine how long a material needs to be cured (the time it takes to get to 90% of the maximum state of cure (MH or maximum torque)). ASTM D5289 (Standard Test Method for Rubber Property—Vulcanization Using Rotorless Cure Meters) was utilized for this examination. Briefly, Moving Die Rheometers (MDR) were used to characterize the cure, or vulcanization, reaction in rubber compounds. The machine has a cavity with a die imbedded in one side which oscillates back and forth measuring torque while the sample is exposed to a temperature similar to that in the curing process, typically between 150° C.-180° C. The torque goes up at the beginning of the test because the sample is cool relative to the testing temperature. The torque then falls as the material softens and flows. As the curing reaction starts to take place, crosslinks start forming, the composition becomes more stiff and the torque increases as the material is no longer able to flow. Once all of the cure has reacted, the torque levels off. The cure time needed in the manufacturing process is estimated by the amount of time that it takes for the cure to start leveling off (i.e. Tc90).

The cure kinetics data is shown in Table 14. All the materials affected the cure rate in some way. They all reduced the Ts1 and Ts2 except for the Blend 1 and the batches with the cure adjustments. Batches containing Inventive Ex. 4, Inventive Ex. 5, Inventive Ex. 6, and Inventive Ex. 1-Adj-3 had similar MH (maximum torque) values to their respective control compounds, while batches containing Blend 1, Inventive Ex. 2, Inventive Ex. 1, and Inventive Ex. 3 reduced the MH. Batches containing Blend 1, Inventive Ex. 2, and Inventive Ex. 6 has slightly increased the Tc90 (the time it takes to get to 90% of the maximum state of cure (MH or maximum torque)) compared to the control, while the other batches shortened the cure time.

TABLE 14
Cure Kinetics of Exemplary Rubbers of the Present Disclosure and Control Rubbers.

| | | | | | | | | | | Inventive | Inventive | Inventive |
|---|---|---|---|---|---|---|---|---|---|---|---|---|
| | | Blend | Inventive | Inventive | Inventive | Inventive | Inventive | Inventive | Control | Ex. 1 | Ex. 1 | Ex. 1 |
| | Control | 1 | Ex. 2 | Ex. 1 | Ex. 3 | Ex. 4 | Ex. 5 | Ex. 6 | 2 | Adj A | Adj B | Adi C |
| MH (dNm) | 14.11 | 11.85 | 13.27 | 12.64 | 12.34 | 14.12 | 14.09 | 14.16 | 12.57 | 12.47 | 15.79 | 14.82 |
| ML (dNm) | 1.83 | 1.66 | 1.73 | 1.55 | 1.54 | 1.78 | 1.94 | 1.67 | 1.78 | 1.52 | 1.69 | 1.63 |
| Ts1 (min) | 1.44 | 1.67 | 0.69 | 1.12 | 1.26 | 0.98 | 0.78 | 1.2 | 1.99 | 2.05 | 1.71 | 1.88 |
| Ts2 (min) | 2.15 | 2.46 | 0.84 | 1.56 | 1.58 | 1.31 | 0.98 | 1.68 | 2.59 | 2.77 | 2.38 | 2.59 |
| Te90 (min) | 10.97 | 12.58 | 11.74 | 8.08 | 9.15 | 9.28 | 11.15 | 7.94 | 8.81 | 6.41 | 5.64 | 5.99 |

Payne Effects of Exemplary Rubbers of the Present Disclosure and Control Rubbers. The Payne Effect is associated with the filler-filler interaction. It measures decrease dynamic modulus as strain is increased which is caused by the breaking/recovery of weak physical bonds linking adjacent filler particles. ASTM D8059 (Measurement of Unvulcanized Dynamic Strain Softening (Payne Effect) Using Sealed Cavity Rotorless Shear Rheometers) was utilized to examine the Payne Effect and the data is shown in Table 15 below. Briefly, the Payne Effect was examined using the same instrument as the MDR but under different parameters. The sample was put through a strain sweep (i.e., from low strain to high strain) and the change in properties from the beginning of the strain sweep (low strain) to the end of the strain sweep (high strain) correlates with dispersion and is attributed to the filler-to-filler interaction in a rubber compound.

TABLE 15
Payne Effects of Exemplary Rubbers of the Present Disclosure and Control Rubbers

| | | | Blend | Inventive | Inventive | Inventive | Inventive | Inventive | Inventive | Control | Inventive |
|---|---|---|---|---|---|---|---|---|---|---|---|
| | | Control | 1 | Ex. 2 | Ex. 1 | Ex. 3 | Ex. 4 | Ex. 5 | Ex. 6 | 2 | Ex. 1 Adj |
| G′@0.100% | 1-Pa | 458 | 438 | 420 | 393 | 416 | 467 | 451 | 450 | 455 | 376 |
| G′@100.000% | kPa | 118 | 113 | 116 | 113 | 118 | 124 | 125 | 119 | 114 | 106 |
| Payne Effect | kPa | 340 | 325 | 304 | 280 | 298 | 342 | 325 | 331 | 340 | 270 |
| (0.1% to 100%) | | | | | | | | | | | |
| % Difference from Control 1 | | | −4.45% | −10.62% | −17.60% | −12.45% | 0.66% | −4.28% | −2.68% | 0.10% | −20.57% |
| G′@1.00% | kPa | 427 | 408 | 392 | 378 | 403 | 445 | 441 | 419 | 424 | 360 |
| G′@100.000% | kPa | 118 | 113 | 116 | 113 | 118 | 124 | 125 | 119 | 114 | 106 |
| Payne Effect | 1-Pa | 309 | 295 | 276 | 264 | 285 | 320 | 316 | 300 | 310 | 254 |
| (1.0% to 100%) | | | | | | | | | | | |

| | | | | | | | | | |
|---|---|---|---|---|---|---|---|---|---|
| % Difference from Control 1 | −4.51% | −10.54% | −14.39% | −7.88% | 3.69% | 2.36% | −2.75% | 0.29% | −17.69% |

Rubbers prepared with Inventive Ex. 1, Inventive Ex. 3, and Inventive Ex. 1-Adj-1 have the lowest Payne Effects which typically correlates to improved filler dispersion.

Durometer, Tensile and Elongation of Exemplary Rubbers of the Present Disclosure and Control Rubbers. Material cured TC90 (time it takes for the material to reach 90% of its maximum torque value during curing) plus 5 minutes and conditioned a minimum of 16 hours at standard laboratory conditions prior to testing. Durometer is a general measurement of hardness by testing the depth of an indentation in the material being tested. Durometer is a measurement of hardness and was examined utilizing the ASTM D2240 (Standard Test Method for Rubber Property-Durometer Hardness) and the data is shown in Table 16. Briefly, an indentor was pressed into the rubber with a certain amount of force and at a certain speed. The durometer, hardness, is not the same as the stiffness, modulus. That is, two compounds with the same durometer can have very different levels of tensile strength, elongation, and modulus.

All the compounds fall within the range of commonly accepted batch to batch variation (typically, +/−5 duro points for production quality control specifications). The tensile strength is the force (stress) required to break a test specimen, while Elongation is how far a specimen stretches before it breaks. Tensile strength and elongation were examined utilizing the ASTM D412 (Standard Test Methods for Vulcanized Rubber and Thermoplastic Elastomers-Tension) and the data is shown in Table 16. Briefly, a tensile machine utilized grips to clamp a dumbbell-shaped specimen and stretch it until it breaks, the amount of force it took to stretch the sample as it breaks was measured. The tensile machine also utilizes extensometer grips that measures how far the dumbbell-shaped specimen is stretched as it is being pulled. The force required to break the specimen is the tensile strength (stress), the amount the specimen stretches before breaking is the ultimate elongation (strain), and the modulus values are recorded along the way as the force required to stretch it a certain amount (i.e. 100% modulus is the force required to stretch it 100% of the original length). All the batches had similar tensile strength as compared to the control compounds except for batches Inventive Ex. 4 and Inventive Ex. 5, which had slightly lower tensile strength. All the batches are similar in elongation to the control batches, and they all maintain above 300% ultimate elongation.

Modulus, in the rubber industry, is the amount of force it takes to stretch a material a certain percent of its original length. Modulus (MPa) at 50%, 100%, 200%, and 300% of the original length is shown in Table 16. The batches with Blend 1 and Inventive Ex. 3 show a slight decrease in modulus compared to the control, but when you consider the spread of results between the first and second control batches, the modulus differences do not seem to be significant.

TABLE 16
Characteristics of Exemplary Rubbers of the Present Disclosure and Control Rubbers

| | | | Stress @ | Strain @ | Stress @) | Stress @ | Stress @ | Stress @ |
|---|---|---|---|---|---|---|---|---|
| | | | Break | Break | 50.000% | 100.000% | 200.0% | 300.0% |
| | | Durometer | (MPa) | (%) | (MPa) | (MPa) | (MPa) | (MPa) |
| Control | Mean | 56 | 17.10 | 343 | 1.10 | 2.24 | 6.97 | 14.05 |
| | St. Dev. | 0.09 | 1.91 | 25 | 0.06 | 0.09 | 0.23 | 0.35 |
| Blend 1 | Mean | 56 | 17.47 | 376 | 1.01 | 1.96 | 6.02 | 12.40 |
| | St. Dev. | 0.21 | 1.56 | 24 | 0.04 | 0.09 | 0.35 | 0.65 |
| Inventive | Mean | 57 | 17.36 | 347 | 1.17 | 2.40 | 7.22 | 14.16 |
| Ex. 2 | St. Dev. | 0.38 | 1.34 | 26 | 0.03 | 0.13 | 0.38 | 0.62 |
| Inventive | Mean | 57 | 17.21 | 355 | 1.15 | 2.34 | 6.92 | 13.54 |
| Ex. 1 | St. Dev. | 0.36 | 0.55 | 11 | 0.02 | 0.09 | 0.30 | 0.47 |
| Inventive | Mean | 57 | 17.90 | 385 | 1.14 | 2.24 | 6.37 | 12.57 |
| Ex. 3 | St. Dev. | 0.31 | 0.84 | 12 | 0.04 | 0.09 | 0.37 | 0.62 |
| Inventive | Mean | 59 | 16.35 | 327 | 1.26 | 2.60 | 7.60 | 14.49 |
| Ex. 4 | St. Dev. | 0.51 | 0.52 | 17 | 0.05 | 0.10 | 0.41 | 0.66 |
| Inventive | Mean | 59 | 15.42 | 319 | 1.27 | 2.58 | 7.42 | 13.89 |
| Ex. 5 | St. Dev. | 0.62 | 1.42 | 26 | 0.06 | 0.11 | 0.40 | 0.51 |
| Inventive | Mean | 59 | 16.63 | 344 | 1.29 | 2.56 | 7.18 | 13.67 |
| Ex. 6 | St. Dev. | 0.51 | 1.07 | 21 | 0.03 | 0.09 | 0.32 | 0.46 |
| Control 2 | Mean | 55 | 13.41 | 317 | 1.14 | 2.03 | 5.90 | 12.34 |
| | St. Dev. | 0.55 | 1.33 | 18 | 0.01 | 0.03 | 0.13 | 0.22 |
| Inventive | Mean | 55 | 12.90 | 307 | 1.12 | 2.10 | 6.16 | 12.60 |
| Ex. 1 Adj | St. Dev. | 0.41 | 1.08 | 19 | 0.02 | 0.07 | 0.26 | 0.45 |

Dispersion of Exemplary Rubbers of the Present Disclosure and Control Rubbers. Dispersion was examined via the ASTM D7723 (Standard Test Method for Rubber Property-Macro-Dispersion of Fillers in Compounds) and the data is shown in Table 17. The Blend 1 reduced dispersion slightly, but other materials either kept the dispersion the same as the control or slightly improved it. Inventive Ex. 6 showed the biggest increase in dispersion percentage.

TABLE 17
Percent Dispersion of Exemplary Rubbers of
the Present Disclosure and Control Rubbers

| | Dispersion Percent (%) |
|---|---|
| Control | 93 |
| Blend 1 | 86 |
| (Inventive Ex. 2) diethylenetriamine (DETA) | 93 |
| oleic acid imidazoline | |
| (Inventive Ex. 1) diethylenetriamine (DETA) | 92 |
| oleic acid amidoamine | |
| (Inventive Ex. 3) diethylenetriamine (DETA) | 95 |
| oleic acid bisamide | |
| (Inventive Ex. 4) triethylenetetramine (TETA) | 91 |
| oleic acid amidoamine | |
| (Inventive Ex. 5) tetraethylenepentamine | 94 |
| (TEPA) oleic acid amidoamine | |
| (Inventive Ex. 6) dimethylaminopropylamine | 97 |
| (DMAPA) oleic acid amidoamine | |
| Control 2 | 98 |
| (Inventive Ex. 1) diethylenetriamine (DETA) | 98 |
| oleic acid amidoamine-Adj-1 | |

Dynamic Mechanical Analysis. Dynamic mechanical analysis was performed with a temperature sweep of 70° C. to 70° C. at 2/minute, 0.5% strain, and 1 hertz (Hz). The data is shown in Table 18 and Table 19 (indexed). Most of the exemplary rubbers of the present disclosure improved the ice traction, wet traction, dry handling, and dry traction, but reduced fuel economy. Higher E′ corresponds to stiffer compound (higher dynamic modulus) and lower hysteresis (heat build-up) during cyclic deformation. Higher E″ corresponds to a more damping compound (absorbs energy) and higher hysteresis (heat build-up) during cycling deformation. Tan δ is the ratio of energy lost to energy stored/returned during cyclic deformation. Typically, higher tan δ indicates higher hysteresis (heat build-up), but it is possible for two compounds with different formulas to have the same tan δ but different for heat build-up depending on filler loading polymer type, etc. The peak of the tan δ curve indicates the glass transition temperature (Tg).

TABLE 18
Dynamic Mechanical Characteristics for Exemplary Rubbers of the Present Disclosure and Control Rubbers

| DMA | Performance | | | Inventive | Inventive | Inventive | Inventive | Inventive | Inventive | | Inventive |
|---|---|---|---|---|---|---|---|---|---|---|---|
| Datapoint | Indicator | Control | Blend 1 | Ex. 2 | Ex. 1 | Ex. 3 | Ex. 4 | Ex. 5 | Ex. 6 | Control 2 | Ex. 1 Adj |
| E′ @ −20° C. | Winter | 51.25 | 40.31 | 72.37 | 48.03 | 62.85 | 68.66 | 69.42 | 70.35 | 37.17 | 33.59 |
| | Traction | | | | | | | | | | |
| Tan δ @ −10° C. | Ice Traction | 0.61 | 0.60 | 0.64 | 0.63 | 0.64 | 0.62 | 0.64 | 0.62 | 0.52 | 0.55 |
| Tan δ @ 0° C. | Wet Traction | 0.34 | 0.34 | 0.38 | 0.36 | 0.37 | 0.37 | 0.38 | 0.37 | 0.30 | 0.30 |
| E′ @ 30° C. | Dry Handling | 6.56 | 4.57 | 7.31 | 5.65 | 7.07 | 7.82 | 7.53 | 8.11 | 6.09 | 5.33 |
| | @ 30° C. | | | | | | | | | | |
| E″ @ 30° C. | Dry Traction | 0.88 | 0.71 | 1.12 | 0.74 | 1.00 | 1.14 | 1.12 | 1.20 | 0.80 | 0.55 |
| | @ 30° C. | | | | | | | | | | |
| Tan δ @ 30° C. | Fuel | 0.14 | 0.15 | 0.15 | 0.13 | 0.14 | 0.15 | 0.15 | 0.15 | 0.13 | 0.10 |
| | Economy @ | | | | | | | | | | |
| | 30° C. | | | | | | | | | | |
| E′ @ 60° C. | Dry Handling | 5.19 | 2.52 | 5.19 | 4.28 | 5.24 | 6.01 | 5.67 | 6.21 | 4.90 | 4.42 |
| | @ 60° C. | | | | | | | | | | |
| Tan δ @ 60° C. | Fuel | 0.10 | 0.15 | 0.12 | 0.09 | 0.11 | 0.11 | 0.11 | 0.11 | 0.10 | 0.08 |
| | Economy @ | | | | | | | | | | |
| | 60° C. | | | | | | | | | | |
| D″ @ 60° C. | Dry Traction | 0.02 | 0.06 | 0.02 | 0.02 | 0.02 | 0.02 | 0.02 | 0.02 | 0.0 | 0.02 |
| | @ 60° C. | | | | | | | | | | |

TABLE 19
Indexed Dynamic Mechanical Characteristics for Exemplary Rubbers of the Present Disclosure and Control Rubbers

| | | | | | | | | | | | | Inven- |
|---|---|---|---|---|---|---|---|---|---|---|---|---|
| | | | | | Inve- | Inven- | Inven- | Inven- | Inven- | Inven- | | tive |
| DMA | Performance | | | Blend | ntive | tive | tive | tive | tive | tive | Control | Ex. 1 |
| Datapoint | Indicator | Indexing | Control | 1 | Ex. 2 | Ex. 1 | Ex. 3 | Ex. 4 | Ex. 5 | Ex. 6 | 2 | Adj |
| E′ @−20° C. | Winter | inversed | 100.0 | 121.3 | 58.8 | 106.3 | 77.4 | 66.0 | 64.5 | 62.7 | 100.0 | 109.6 |
| | Traction | | | | | | | | | | | |
| Tan δ @−10° C. | Ice | as is | 100.0 | 98.3 | 106.1 | 104.1 | 105.6 | 102.8 | 104.8 | 102.1 | 100.0 | 104.8 |
| | Traction | | | | | | | | | | | |
| Tan δ @ 0° C. | Wet | as is | 100.0 | 100.3 | 111.7 | 106.5 | 107.6 | 108.2 | 110.6 | 108.2 | 100.0 | 97.4 |
| | Traction | | | | | | | | | | | |
| E′ @ 30° C. | Dry Handling | as is | 100.0 | 69.7 | 111.4 | 86.1 | 107.8 | 119.2 | 114.8 | 123.6 | 100.0 | 87.5 |
| | @ 30° C. | | | | | | | | | | | |
| E″ @ 30° C. | Dry Traction | as is | 100.0 | 79.8 | 126.1 | 84.0 | 112.8 | 129.0 | 126.6 | 135.5 | 100.0 | 68.8 |
| | @ 30° C. | | | | | | | | | | | |
| Tan δ @ 30° C. | Fuel | inversed | 100.0 | 85.9 | 86.7 | 102.2 | 95.6 | 91.9 | 89.6 | 90.4 | 100.0 | 121.4 |
| | Economy @ | | | | | | | | | | | |
| | 30° C. | | | | | | | | | | | |
| E′ @ 60° C. | Dry Handling | | 100.0 | 48.6 | 100.0 | 82.5 | 101.0 | 115.8 | 109.2 | 119.7 | 100.0 | 90.2 |
| | @ 60° C. | | | | | | | | | | | |
| Tan δ @ 60° C. | Fuel | inversed | 100.0 | 57.3 | 82.5 | 110.7 | 97.1 | 96.1 | 93.2 | 93.2 | 100.0 | 123.2 |
| | Economy @ | | | | | | | | | | | |
| | 60° C. | | | | | | | | | | | |
| D″ @ 60° C. | Dry Traction | | 100.0 | 290.9 | 117.8 | 109.2 | 102.7 | 89.8 | 98.3 | 89.8 | 100.0 | 85.1 |
| | @ 60° C. | | | | | | | | | | | |

### Abrasion Resistance Analysis.

Abrasion resistance was examined via ASTM D5963 (Standard Test Method for Rubber Property—Abrasion Resistance (Rotary Drum Abrader)). Briefly, abrasion resistance was examined by mounting a molded rubber button in a sample holder that rubs the test specimen against a rotating drum that is covered with a specific type of sandpaper, as outlined in the ASTM method. The test specimen itself can be either (i) “non-rotating” where it slide across the surface of the rotating drum, or (ii) “rotating” where it spins across the surface of the rotating drum. Here, the data was acquired with a fixed (non-rotating) method. The mass loss and volume loss are shown below in Table 20.

The variation between the controls highlights the accuracy of the testing method. As seen from the data, there is no notable effect on abrasion resistance for any of the inventive examples, relative to the controls, with the exception of Inventive Ex. 5, Inventive Ex. 6 and Inventive Ex. 1 Adj being slightly lower in abrasion resistance.

TABLE 20
Abrasion Resistance Data for Exemplary Rubbers of the Present Disclosure and Control Rubbers

| | | | Inventive | Inventive | Inventive | Inventive | Inventive | Inventive | | Inventive |
|---|---|---|---|---|---|---|---|---|---|---|
| | Control | Blend 1 | Ex. 2 | Ex. 1 | Ex. 3 | Ex. 4 | Ex. 5 | Ex. 6 | Control 2 | Ex. 1 Adj |
| Average DIN Mass | 65 | 82 | 68 | 67 | 73 | 69 | 84 | 111 | 79 | 91 |
| Loss, mg | | | | | | | | | | |
| Average Abrasion | 97 | 122 | 102 | 103 | 113 | 103 | 129 | 167 | 119 | 142 |
| Loss, mm3 | | | | | | | | | | |
| Abrasion Resistance | 159 | 127 | 153 | 144 | 131 | 145 | 119 | 90 | 127 | 107 |
| Index, % | | | | | | | | | | |

Comparing and Ranking the Compounds. All the compounds were ranked from 1 (worst) to 10 (best) for the various properties listed below in Table 21. Using the total scores, the compounds were ranked from best to worst as shown below in Table 22. Inventive Ex. 3 had the best overall performance while Blend 1 had the worst overall performance.

The compounding materials of the present disclosure did not significantly affect the physical properties (tensile, elongation, modulus, and durometer) of the rubber, but did cause a shift in the tire performance indicators, such as fuel economy, ice traction, and wet traction. Specifically, Inventive Ex. 3 performed the same or slightly better on all the tire predictors other than winter traction, as well as having one of the lowest Payne effects. Inventive Ex. 1 had a low Payne effect and great fuel economy, which is critical in the electric vehicle space.

The compounding materials of the present disclosure can help push the limits on the tricky triangle of traction/grip, wear/abrasion, and rolling resistance (fuel economy), without compromising the processability and physical properties of the compound.

TABLE 21
Comparison of Exemplary Rubbers of the Present Disclosure and Control Rubbers

| | | | Inventive | Inventive | Inventive | Inventive | Inventive | Inventive | | Inventive |
|---|---|---|---|---|---|---|---|---|---|---|
| | Control | Blend 1 | Ex. 2 | Ex. 1 | Ex. 3 | Ex. 4 | Ex. 5 | Ex. 6 | Control 2 | Ex. 1 Adj |
| Mooney Scorch | 7 | 9 | 1 | 4 | 5 | 3 | 2 | 6 | 10 | 8 |
| Payne Effect | 2 | 6 | | 9 | 7 | 5 | 3 | 4 | 1 | 10 |
| Winter Traction | 6 | 10 | 1 | 8 | 5 | 4 | 3 | 2 | 7 | 9 |
| Ice Traction | 3 | 1 | 10 | 6 | 9 | 5 | | 4 | 2 | 7 |
| Wet traction | 2 | 4 | 10 | 5 | 6 | | 9 | 7 | 3 | 1 |
| Dry Handling | 5 | 1 | 7 | 2 | 6 | 9 | 8 | 10 | 4 | 3 |
| Dry Traction | 4 | 2 | ? | 3 | 6 | 9 | 8 | 10 | 5 | 1 |
| Fuel Economy | 8 | 1 | 2 | 9 | 6 | 5 | 3 | 4 | 7 | 10 |
| Abrasion | 10 | 5 | 9 | 7 | 6 | 8 | 3 | 1 | 4 | 2 |
| Resistance | | | | | | | | | | |
| Total: | 47 | 39 | 55 | 53 | 56 | 56 | 47 | 48 | 43 | 51 |

TABLE 22
Ranking of Rubbers of the Present Disclosure

| Rank | Additive Composition | Score |
|---|---|---|
| 1 | Inventive Ex. 3 | 56 |
| 2 | Inventive Ex. 4 | 56 |
| 3 | Inventive Ex. 2 | 55 |
| 4 | Inventive Ex. 1 | 53 |
| 5 | Inventive Ex. 1 Adj | 51 |
| 6 | Inventive Ex. 6 | 48 |
| 7 | Inventive Ex. 5 | 47 |
| 8 | Control | 47 |
| 9 | Control 2 | 43 |
| 10 | Blend 1 | 39 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references or publication are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range. “Combinations” is inclusive of blends, mixtures, alloys, reaction products, and the like. The terms “first”, “second”, and the like, do not denote any order, quantity, or importance, but rather are used to denote one element from another.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A rubber composition comprising, consisting essentially or, or consisting of:
an additive compositions made by a process comprising, consisting essentially of, or consisting of, reacting (A) a fatty acid composition with (B) a unsubstituted or substituted, linear or branched polyalkylpolyamine;
one or more elastomer; and
one or more filler that includes silica.

2. The rubber of claim 1, wherein:
the fatty acid composition includes or is oleic acid, stearic acid, palmitic acid, linoleic acid, linolenic acid, isostearic acid, ricolenic acid, a natural fatty acid mixture, crude tall oil (CTO), distilled tall oil, tall oil fatty acids (TOFA), vegetable oil, soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof;
the unsubstituted or substituted, linear or branched polyalkylpolyamine includes or is diethylenetriamine (DETA), dimethylaminopropylamine (DMAPA), triethylenetetramine (TETA), tetraethylenepentamine (TEPA), or a mixture thereof; or
a combination thereof.

3. The rubber of claim 1, wherein:
the fatty acid composition includes or is oleic acid, stearic acid, palmitic acid, linoleic acid, linolenic acid, isostearic acid, ricolenic acid, or a mixture thereof;
the unsubstituted or substituted, linear or branched polyalkylpolyamine includes or is diethylenetriamine (DETA), dimethylaminopropylamine (DMAPA), or a mixture thereof; or
a combination thereof.

4. The rubber of claim 1, wherein:
the fatty acid composition includes or is oleic acid;
the unsubstituted or substituted, linear or branched polyalkylpolyamine includes or is diethylenetriamine (DETA); or
a combination thereof.

5. The rubber of claim 1, wherein the additive composition includes, consists essentially of, or consists of, one or more compound with the chemical structure: 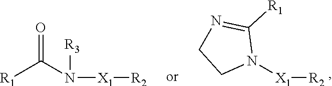
wherein:
X₁ has the chemical structure 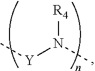
wherein n is an integer from 1, 2, 3, 4, or 5;
X₂ has the chemical structure 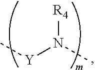
wherein m is an integer from 1, 2, 3, 4, or 5;
Y is a C₁₋₄ hydrocarbon chain;
R₁ is a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups;
R₂ is a hydrogen, a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups, or 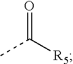
R₃ is a hydrogen or a C₁₋₆ linear or branched alkyl;
each R₄ is a hydrogen or a C₁₋₆ linear or branched alkyl; and
R₅ is a C₈₋₃₆ hydrocarbon chain with 1, 2, or 3 degrees of unsaturation (e.g., a C₈₋₂₂ hydrocarbon chain with 1, 2, or 3 degrees of unsaturation or a C₈₋₂₂ or C₈₋₁₈ hydrocarbon chain with 1 or 2 degrees of unsaturation), optionally 1, or 2 carbonyl groups and/or carboxylic groups.

6. The use of claim 5, wherein:
R₂ is a hydrogen, C₈₋₃₆, C₈₋₂₂, or C₈₋₁₈ hydrocarbon chain with 0, 1, or 2 degrees of unsaturation (e.g., C₈₋₃₆, C₈₋₂₂, or C₈₋₁₈ hydrocarbon chain with 1 or 2 degrees of unsaturation) and optionally 1 or 2 carbonyl groups and/or carbocyclic groups, or 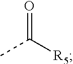
R₂ is a hydrogen or C₈₋₃₆, C₈₋₂₂, or C₈₋₁₈ hydrocarbon chain with 0, 1, or 2 degrees of unsaturation (e.g., C₈₋₃₆, C₈₋₂₂, or C₈₋₁₈ hydrocarbon chain with 1 or 2 degrees of unsaturation) and optionally 1 or 2 carbonyl groups and/or carbocyclic groups;
R₂ is a hydrogen, C₈₋₃₆, C₈₋₂₂, or C₈₋₁₈ hydrocarbon chain with 0 or 1 degrees of unsaturation (e.g., C₈₋₂₂ or C₈₋₁₈ hydrocarbon chain with 0 or 1 degrees of unsaturation) and optionally 1 or 2 carbonyl groups and/or carbocyclic groups, or 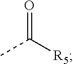
R₂ is a hydrogen, C₈₋₂₂ or C₈₋₁₈ hydrocarbon chain with 1, 2, or 3 degrees of unsaturation, or 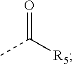
or
R₂ is a hydrogen or

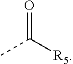

7. The rubber of claim 1, wherein the additive composition comprises, consists essentially, or consists of:
diethylenetriamine (DETA) oleic acid amidoamine,
diethylenetriamine (DETA) oleic acid imidazoline,
diethylenetriamine (DETA) oleic acid bisamide,
triethylenetetramine (TETA) oleic acid amidoamine,
tetraethylenepentamine (TEPA) oleic acid amidoamine,
dimethylaminopropylamine (DMAPA) oleic acid amidoamine, or
a combination thereof.

8. The rubber of claim 1, wherein:
the one or more elastomer includes one or more natural rubber, one or more synthetic rubber, or a combination thereof;
the one or more elastomer includes a synthetic rubber that includes one or more diene-based rubber;
the one or more elastomer includes a synthetic rubber that includes one or more diene-based rubber that includes a styrene-butadiene copolymer rubber, a polybutadiene, or a combination thereof;
the one or more elastomer includes a functionalized elastomer;
the silica is silicon dioxide; or
a combination thereof.

9. The rubber of claim 1, further comprising, consisting essentially of, or consisting of:
one or more plasticizer;
one or more coupling agent; or
a combination thereof.

10. The rubber of claim 9, wherein:
the one or more plasticizer includes a processing oil, an aromatic oil (or a combination thereof;
the one or more coupling agent includes sulfur functional organosilanes, bis(triethoxysilylpropyl) tetrasulfide, bis(triethoxysilylpropyl) disulfide, 3-thiocyanatopropyltriethoxysilane, or a mixture thereof; or
a combination thereof.

11. The rubber of claim 1, further comprising, consisting essentially of, or consisting of:
one or more antiaging agent;
one or more vulcanization accelerator; or
a combination thereof.

12. The rubber of claim 1, wherein:
the one or more vulcanization accelerator includes stearic acid, zinc oxide, or a combination thereof;
the one or more antiaging agent includes one or more antioxidant;
the one or more antiaging agent includes one or more antiozonant;
the one or more filler include one or more carbon black;
the one or more filler includes N330 carbon black; or
a combination thereof.

13. The rubber of claim 1, wherein:
the rubber further comprises, consisting essentially of, or consisting of, one or more cross-linking or vulcanization agent;
the one or more vulcanization accelerator include a sulfenamide-based accelerator;
the one or more coupling agent further includes diphenyl guanidine (DPG); or
a combination thereof.

14. The rubber of claim 1, wherein:
the synthetic rubber is present in an amount of at least 50 parts per hundred of rubber (PHR);
the additive composition is present in an amount of about 1 to about 10 PHR;
the one or more filler is present in an amount of about 50 to about 150 PHR;
the one or more plasticizer is present in an amount of about 15 to about 50 PHR;
the one or more coupling agent is present in an amount of about 4 to about 12 PHR;
the one or more vulcanizing accelerator is present in amount of about 2 to about 8.5 PHR;
the one or more antiaging agent is present in an amount of about 3 to about 8 PHR;
the one or more cross-linking or vulcanization agent is present in an amount of about 0.4 to about 2.4 PHR; or
a combination thereof.

15. The rubber of claim 1, wherein:
the styrene butadiene copolymer rubber is present in an amount of about 60 to about 90 parts per hundred of rubber (PHR);
the polybutadiene is present in an amount of about 10 to about 40 PHR;
the one or more silica is present in an amount of about 55 to about 150 PHR;
the one or more carbon black is present in an amount of about 5 to about 20 PHR;
the organosilane or sulfur functional organosilane is present in an amount of about 4 to about 8 PHR;
the diphenyl guanidine (DPG) is present in an amount of about 0.5 to about 4 PHR;
the sulfenamide-based accelerator is present in an amount of about 0.5 to about 3 PHR;
the zinc oxide is present in an amount of about 1 to about 4 PHR;
the stearic acid is present in an amount of about 0.5 to about 1.5 PHR;
the one or more antioxidant is present in an amount of about 2 to about 6 PHR;
the one or more antiozonant is present in an amount of about 1 to about 2 PHR; or
a combination thereof.

16. A method of making the rubber composition of claim 1, the method comprising, consisting essentially of, or consisting of, contacting one or more filler that includes one or more silica, one or more elastomer, and the additive composition.

17. The method of claim 16, wherein contacting the one or more silica, the one or more rubber, and the additive composition comprises, consisting essentially of, or consisting of:
preparing a first mixture comprising combining and/or mixing the one or more elastomer, the one or more silica, the one or more coupling agent, the one or more plasticizer, or a combination thereof;
preparing a second mixture comprising combining and/or mixing the first mixture, at least one of the one or more filler, at least one of the one or more plasticizer, the one or more antiaging agent, the one or more vulcanizing accelerator, the additive composition, or a combination thereof;
preparing a third mixture comprising combining and/or mixing the second mixture, at least one of the one or more of the vulcanizing accelerator, at least one of the one or more coupling agent, at least one of the one or more cross-linking or vulcanizing agent, or a combination thereof; or
a combination thereof.

18. The method of claim 17, wherein:
(i) preparing the first mixture includes:
adding the one or more plasticizer to the mixture the one or more elastomer, the one or more silica, and/or the one or more coupling agent, at a temperature of about 75° C. to about 95° C.;
mixing/sweeping the first mixture at a temperature of about 100° C. to about 115° C.;
mixing/sweeping the mixture at a temperature of about 115° C. to about 135° C.;
holding the first mixture at a temperature of about 145° C. to about 160° C.; or
a combination thereof;
(ii) preparing the second mixture includes:
combining the first mixture, the at least one of the one or more filler, and the at least one of the one or more plasticizer;
combining at a temperature of about 75° C. to about 90° C.;
mixing/sweeping the second mixture at a temperature of about 100° C. to about 115° C.;
holding the third mixture at a temperature of about 130° C. to about 145° C.; or
a combination thereof;
(iii) preparing the third mixture includes:
combining the second mixture, the at least one of one or more vulcanizing accelerator, the at least one of the one or more coupling agent, the one or more cross-linking or vulcanizing agent, or a combination thereof;
mixing/sweeping the third composition at a temperature of about 75° C. to about 110° C.; or
a combination thereof; or
(iv) a combination thereof.

19. A tire comprising or consisting essentially of an additive composition, wherein the additive composition is made by a process comprising, consisting essentially of, or consisting of, reacting (A) a fatty acid composition with (B) a unsubstituted or substituted, linear or branched polyalkylpolyamine.

20. The tire of claim 19, wherein:
(a) the fatty acid composition includes or is oleic acid, stearic acid, palmitic acid, linoleic acid, linolenic acid, isostearic acid, ricolenic acid, a natural fatty acid mixture, crude tall oil (CTO), distilled tall oil, tall oil fatty acids (TOFA), vegetable oil, soybean oil, olive oil, canola oil, coconut oil, tallow oil, canola oil, sesame oil, rice bran oil, almond oil, rapeseed oil, safflower oil, grapeseed oil, thistle oil, hemp oil, sunflower oil, wheat germ oil, pumpkin seed oil, peanut oil, palm oil, palm kernel oil (PKO), palm fatty acid distillate (PFAD), algae oil, castor oil, or a mixture thereof; the unsubstituted or substituted, linear or branched polyalkylpolyamine includes or is diethylenetriamine (DETA), dimethylaminopropylamine (DMAPA), triethylenetetramine (TETA), tetraethylenepentamine (TEPA), or a mixture thereof; or a combination thereof;
(b) the fatty acid composition includes or is oleic acid, stearic acid, palmitic acid, linoleic acid, linolenic acid, isostearic acid, ricolenic acid, or a mixture thereof; the unsubstituted or substituted, linear or branched polyalkylpolyamine includes or is diethylenetriamine (DETA), dimethylaminopropylamine (DMAPA), or a mixture thereof; or a combination thereof; or
(c) the fatty acid composition includes or is oleic acid; the unsubstituted or substituted, linear or branched polyalkylpolyamine includes or is diethylenetriamine (DETA); or a combination thereof; or
(d) a combination thereof.

21. The tire of claim 19, wherein the additive composition includes, consists essentially of, or consists of, one or more compound with the chemical structure: 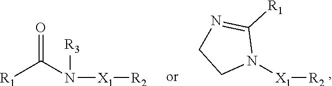
wherein:
X₁ has the chemical structure 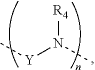
wherein n is an integer from 1, 2, 3, 4, or 5;
X₂ has the chemical structure 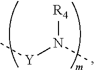
wherein m is an integer from 1, 2, 3, 4, or 5;
Y is a C₁₋₄ hydrocarbon chain;
R₁ is a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups;
R₂ is a hydrogen, a C₈₋₃₆ hydrocarbon with 0, 1, 2, or 3 degrees of unsaturation (e.g., a linear or branched C₈₋₂₂ or C₈₋₁₈ hydrocarbon chain or a C₈₋₂₂ or C₈₋₁₈ hydrocarbon chain, each with 0, 1, 2, or 3 degrees of unsaturation) and optionally 1, 2, or 3 carbonyl groups and/or carbocyclic groups, or 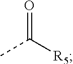
R₃ is a hydrogen or a C₁₋₆ linear or branched alkyl;
each R₄ is a hydrogen or a C₁₋₆ linear or branched alkyl; and
R₅ is a C₈₋₃₆ hydrocarbon chain with 1, 2, or 3 degrees of unsaturation (e.g., a C₈₋₂₂ hydrocarbon chain with 1, 2, or 3 degrees of unsaturation or a C₈₋₂₂ or C₈₋₁₈ hydrocarbon chain with 1 or 2 degrees of unsaturation), optionally 1, or 2 carbonyl groups and/or carboxylic groups.

22. The tire of claim 19, wherein the additive composition comprises, consists essentially, or consists of:
diethylenetriamine (DETA) oleic acid amidoamine,
diethylenetriamine (DETA) oleic acid imidazoline,
diethylenetriamine (DETA) oleic acid bisamide,
triethylenetetramine (TETA) oleic acid amidoamine,
tetraethylenepentamine (TEPA) oleic acid amidoamine,
dimethylaminopropylamine (DMAPA) oleic acid amidoamine, or
a combination thereof.

23. The tire of claim 19, further comprising, consisting essentially of, or consisting of,
one or more elastomer;
one or more filler that includes silica;
one or more plasticizer;
one or more coupling agent;
one or more antiaging agent;
one or more cross-linking or vulcanization agent;
one or more vulcanization accelerator;
a framework or structural reinforcement; or
a combination thereof.

24. The tire of claim 23, wherein:
the one or more elastomer includes one or more natural rubber, one or more synthetic rubber, or a combination thereof;
the one or more elastomer includes a synthetic rubber that includes one or more diene-based rubber;
the one or more elastomer includes a synthetic rubber that includes one or more diene-based rubber that includes a styrene-butadiene copolymer rubber, a polybutadiene, or a combination thereof;
the one or more elastomer includes a functionalized elastomer;
the silica is silicon dioxide;
the one or more plasticizer includes a processing oil, an aromatic oil, or a combination thereof;
the one or more coupling agent includes sulfur functional organosilanes, bis(triethoxysilylpropyl) tetrasulfide, bis(triethoxysilylpropyl) disulfide, 3-thiocyanatopropyltriethoxysilane, or a mixture thereof;
the one or more vulcanization accelerator includes stearic acid, zinc oxide, or a combination thereof;
the one or more antiaging agent includes one or more antioxidant;
the one or more antiaging agent includes one or more antiozonant;
the one or more filler include one or more carbon black;
the one or more filler includes N330 carbon black;
the framework or structure reinforcement include a metal, a textile/fabric, or a combination thereof; or
a combination thereof.
